(19) United States
(12) Patent Application Publication
(10) Pub. No.: US 2026/0370996 A1
(43) Pub. Date: Nov. 19, 2026

(54) AUDIO WEARABLE DEVICE ASSOCIATED WITH THERMOREGULATION

(71) Applicant: QUALCOMM Incorporated, San Diego, CA (US)

(72) Inventors: Guruprasad KAMBAPPA SHANMUKAPPA, Bangalore (IN); Sourabh MALI, Dewas (IN); Jothi Prakash VAIRAKANI, Chennai (IN); Parthasarathy GOVINDASAMY, Coimbatore (IN)

(21) Appl. No.: 19/207,626

(22) Filed: May 14, 2025

(51) Int. Cl. H04R 1/10; G01K 13/20; G05D 23/19; H04R 1/1025; H04R 3/00

(52) U.S. Cl. CPC H04R 1/1041; G01K 13/20; G05D 23/1917; H04R 1/1025; H04R 3/007; H04R 1/1008; H04R 1/1016; H04R 2201/107; H04R 2420/07

(57) ABSTRACT

An audio device includes a first temperature sensor configured to generate first sensor data that indicates a first temperature associated with the ear of the user. The audio device further includes a heat element configured to generate heat, and one or more processors. The one or more processors are configured to receive the first sensor data from the first temperature sensor, and control the heat element based on a result of a comparison associated with the first temperature and a threshold.

### I. FIELD

The present disclosure is generally related to a wearable audio device associated with thermoregulation, such as an in-ear or over-ear wearable audio device that is configured to provide adaptive temperature control.

### II. DESCRIPTION OF RELATED ART

Wearable audio devices, such as earbuds and headsets, have become a part of everyday life. For example, wearable audio devices can be used to listen to audio content, participate in wireless telephone calls, and improve hearing, situational awareness, intelligibility of speech, etc. in many circumstances.

Cold weather can present challenges for the usability of traditional wearable audio devices, sometimes making the wearable audio device uncomfortable or even painful to use. For example, when ambient temperatures are below freezing, materials of the wearable audio device may freeze or provide inadequate thermal insulation for a user's ears, which can cause ear irritation, numbness, and/or pain to the user of the wearable audio device. Such irritation, numbness, and/or pain can make prolonged use of the wearable audio device uncomfortable for outdoor activities (e.g., commuting, exercising, or working). Furthermore, cold weather environments can lead to increased earwax buildup in the ear of the user as the ear canal reacts to changing temperatures, often causing ear canal irritation, blockages, and discomfort. Additionally, low ambient temperatures and moisture from environmental changes can lead to the accumulation of condensation on or in the wearable audio device which can damage sensitive electronics, affecting audio quality and reducing lifespan of the wearable audio device.

### III. SUMMARY

According to one implementation of the present disclosure, an audio device includes a first temperature sensor configured to generate first sensor data that indicates a first temperature associated with an ear of a user, and a heat element configured to generate heat. The audio device also includes one or more processors configured to receive the first sensor data from the first temperature sensor, and control the heat element based on a result of a comparison associated with the first temperature and a threshold.

According to another implementation of the present disclosure, a method of operating a processor of an audio device includes receiving, from a first temperature sensor of the audio device, first sensor data that indicates a first temperature associated with an ear of a user. The method further includes controlling, based on a result of a comparison associated with the first temperature and a threshold, heat generation of a heat element of the audio device.

According to another implementation of the present disclosure, a non-transitory computer-readable medium stores instructions that are executable by one or more processors to cause the one or more processors to receive, from a first temperature sensor of the audio device, first sensor data that indicates a first temperature associated with an ear of a user. The instructions also cause the one or more processors to perform a comparison based on the first temperature and a threshold. The instructions further cause the one or more processors to control, based on a result of the comparison, heat generation of a heat element of the audio device.

According to another implementation of the present disclosure, an apparatus includes means for generating first sensor data that indicates a first temperature associated with an ear of a user. The apparatus further includes means for generating heat. The apparatus includes means for controlling, based on a result of a comparison associated with the first temperature and a threshold, the means for generating heat.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system including an audio device to provide adaptive temperature control, in accordance with one or more aspects of the present disclosure.

FIG. 2 is a diagram of an example of a method associated with the system of FIG. 1, in accordance with one or more aspects of the present disclosure.

FIG. 3 is a diagram of an example of the audio device of FIG. 1, in accordance with some examples of the present disclosure.

FIG. 4 is a diagram of another example of the audio device of FIG. 1, in accordance with some examples of the present disclosure.

FIG. 5 is a diagram of an example of an integrated circuit operable to provide adaptive temperature control, in accordance with some examples of the present disclosure.

FIG. 6 is a diagram of a headset operable to provide adaptive temperature control, in accordance with some examples of the present disclosure.

FIG. 7 is a diagram of a headset, such as a virtual reality, mixed reality, or augmented reality headset, operable to provide adaptive temperature control, in accordance with some examples of the present disclosure.

FIG. 8 is a diagram of earbuds operable to provide adaptive temperature control, in accordance with some examples of the present disclosure.

FIG. 9 is a diagram of a hearing aid device operable to provide adaptive temperature control, in accordance with some examples of the present disclosure.

FIG. 10 is a diagram of a system that includes a mobile device operable to support an audio device configured to provide adaptive temperature control, in accordance with some examples of the present disclosure.

FIG. 11 is a diagram of a system that includes a voice-controlled speaker system operable to support an audio device configured to provide adaptive temperature control, in accordance with some examples of the present disclosure.

FIG. 12 is a diagram of a system that includes a wearable electronic device operable to support an audio device configured to provide adaptive temperature control, in accordance with some examples of the present disclosure.

FIG. 13 is a diagram of a system that includes a first example of a vehicle operable to support an audio device configured to provide adaptive temperature control, in accordance with some examples of the present disclosure.

FIG. 14 is a diagram of a system that includes a second example of a vehicle operable to support an audio device configured to provide adaptive temperature control, in accordance with some examples of the present disclosure.

FIG. 15 is a diagram of an example of a method of providing adaptive temperature control, in accordance with some aspects of the present disclosure.

FIG. 16 is a block diagram of an illustrative example of a device that is operable to support adaptive temperature control, in accordance with one or more aspects of the present disclosure.

### V. DETAILED DESCRIPTION

The above-described problems associated with wearable audio devices are solved by providing a wearable audio device that can perform adaptive temperature control as described herein. The present disclosure provides systems, devices, apparatus, methods, and computer-readable media for adaptive temperature control of a wearable audio device (e.g., an audio device), such as an earbud, a headset, or a hearing protection device (e.g., an earplug or an earmuff). Some aspects more specifically relate to providing dynamic warmth, health monitoring, and/or one or more safety features using the audio device. In some embodiments, an audio device is configured to be coupled to an ear of a user, a heat element (e.g., a graphene heat element or a carbon fiber heat element) configured to generate heat, and one or more sensors. In some embodiments, the heat element is included in a housing or an interface (e.g., an ear tip or an earcup padding). The one or more sensors may include a first sensor configured to measure a temperature of an ear (e.g., an ear canal) of a user of the audio device, a second sensor configured to measure an ambient temperature, a third sensor configured to measure a temperature of the audio device, a fourth sensor configured to measure an amount of moisture associated with a cavity of the audio device, or a combination thereof. The audio device also includes a processor (e.g., a controller) that is configured to control the heat element based on sensor data received from the one or more sensors. For example, the heat element may be controlled based on the sensor data indicating that a body temperature of the user is outside of a threshold range. As another example, the heat element may be controlled based on the sensor data indicating that the ambient temperature is less than or equal to a low environment temperature threshold. In some examples, the heat element may be controlled to be deactivated based on a device temperature being greater than or equal to an overheat threshold. As another example, the heat element may be controlled based on an amount of moisture being greater than or equal to a moisture content threshold. In some embodiments, the heat element may be controlled based on the body temperature of the user being less than or equal to a hypothermia alert threshold, and in such an example, the processor may generate a notification that indicates for the user to seek warmth.

Particular implementations of the subject matter described in this disclosure can be implemented to realize one or more of the following technical advantages. In some aspects, the present disclosure provides techniques that support adaptive temperature control of an audio device, such as a wearable audio device configured to be worn on, in, or over an ear of a user. In some aspects, the techniques enable the audio device to perform the adaptive temperature control based on body temperature data associated with thermoregulation of a user, and the adaptive temperature control can provide comfort or warmth to the user, maintain or promote ear hygiene (e.g., minimize wax accumulation in an ear canal), or a combination thereof. Additionally, or alternatively, the techniques can provide health monitoring associated with a user, such as identification of an uncomfortable or hazardous condition, which may include hypothermia. Additionally, or alternatively, the techniques enable the audio device to perform the adaptive temperature control based on an environmental condition, such as ambient temperature, which can provide comfort or warmth to the user in unpleasant environmental conditions, such as when the audio device is used in a cold weather or freezing conditions. In some other aspects, the techniques enable safe operation of the audio device by maintaining a device temperature (e.g., a heat level) that prevents overheating or underheating and that satisfies one or more safety standards. In some other aspects, the techniques also prevent moisture-related damage to the audio device and maintain consistent performance of the audio device in harsh conditions, such as wet conditions, hot conditions, or cold conditions. Thus, the techniques described herein that support adaptive temperature control of an audio device can enhance safety and durability of the audio device while also promoting health of a user of the audio device.

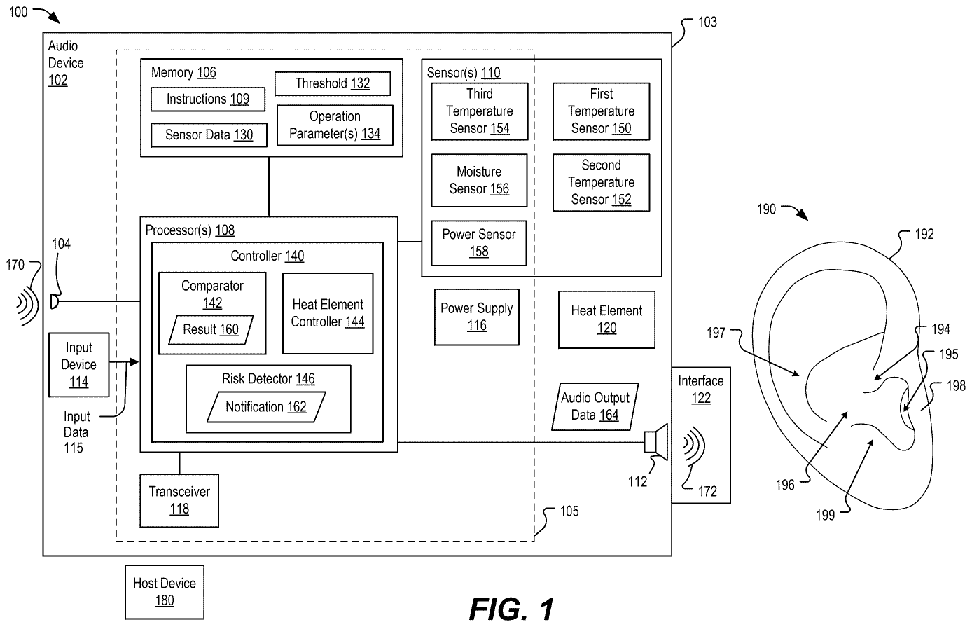

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts an audio device 102 including one or more processors (“processor(s)” 108 of FIG. 1), which indicates that in some implementations the audio device 102 includes a single processor 108 and in other implementations the audio device 102 includes multiple processors 108. For ease of reference herein, such features are generally introduced as “one or more” features and are subsequently referred to in the singular or optional plural (as indicated by “(s)”) unless aspects related to multiple of the features are being described.

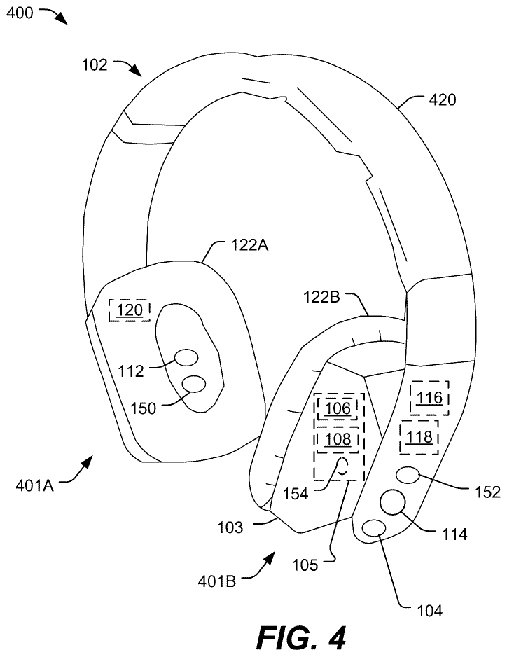

In some drawings, multiple instances of a particular type of feature are used. Although these features are physically and/or logically distinct, the same reference number is used for each, and the different instances are distinguished by addition of a letter to the reference number. When the features as a group or a type are referred to herein-e.g., when no particular one of the features is being referenced, the reference number is used without a distinguishing letter. However, when one particular feature of multiple features of the same type is referred to herein, the reference number is used with the distinguishing letter. For example, referring to FIG. 4, multiple interfaces are illustrated and associated with reference numbers 122A and 122B. When referring to a particular one of these interfaces, such as an interface 122A, the distinguishing letter “A” is used. However, when referring to any arbitrary one of these interfaces or to these interfaces as a group, the reference number 122 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 is a block diagram of an example of a system 100 including an audio device 102 to provide adaptive temperature control, in accordance with one or more aspects of the present disclosure. The system 100 includes the audio device 102 and a host device 180. The audio device 102 may include a wearable audio device, such as an earbud, a hearing aid, a headset, or a hearing protection device (e.g., an earplug or an earmuff), as illustrative, non-limiting examples. The audio device 102 is operable to monitor a temperature or thermoregulation associated with a user 190 and/or to provide adaptive temperature control.

The audio device 102 includes, or is coupled to, a housing 103, a microphone 104, a memory 106 (e.g., a memory device), one or more processors 108 (collectively referred to herein as the “processor 108”), one or more sensors 110 (collectively referred to herein as the “sensor 110”), a speaker 112, an input device 114, a power supply 116, a heat element 120, an interface 122, and a transceiver 118. The housing 103 includes a material, such as a hypoallergenic, heat-resistant material that is configured for efficient heat regulation and/or that prevents discomfort or skin irritation by the user 190. The material may include medical-grade silicone, thermoplastic polyurethane (TPU), polyimide, a graphene, a foam, composites thereof, or a combination thereof, as illustrative, non-limiting examples. The housing 103 defines a cavity 105 (e.g., a space) in which one or more electrical devices or components are positioned. For example, the memory 106, the processor 108, at least one sensor 110, the power supply 116, or the transceiver 118 may be positioned in the cavity 105, as shown in FIG. 1 by the memory 106, the processor 108, the sensor 110, the power supply 116, and the transceiver 118 being located within the dashed lines that represent the cavity 105. In alternative embodiments, one or more of the memory 106, the processor 108, the sensor 110, the power supply 116, or the transceiver 118 may not be positioned in the cavity 105. Additionally, or alternatively, the heat element 120, at least a portion of the microphone 104, at least a portion of the speaker 112, or a combination thereof, may be positioned in the cavity.

In some embodiments, at least one of the one or more electrical devices or components positioned in the cavity 105 are insulated from the heat element 120, which may increase the likelihood of or ensure reliable performance of the electrical device or component. Additionally, or alternatively, an anti-fogging technology (e.g., a coating, a treatment, or a film) may be provided on a surface of the housing 103 that defines the cavity 105, at least one of the one or more electrical devices or components in the cavity 105, or a combination thereof. The anti-fogging technology may be configured to prohibit an accumulation of moisture on a surface covered by the anti-fogging technology, maintain a clear/clean surface covered by the anti-fogging technology, and promote optimal functionality of an electrical device or component.

The microphone 104 is coupled to the processor 108 and configured to generate an input signal based on sound 170 detected from the environment 101 (e.g., an ambient environment of the audio device 102). In some aspects, the microphone 104 includes a first microphone (e.g., a feedforward microphone), a second microphone (e.g., a feedback microphone), a third microphone (e.g., a voice microphone), or a combination thereof. The sound 170 can include a target sound, such as speech, as well as non-target sounds (e.g., noise). It is noted that while the embodiment of the audio device 102 of the system 100 is shown as including the microphone 104, the microphone 104 may be optional and, in other embodiments, the audio device 102 may not include the microphone 104.

The memory 106 may include one or more memory devices, such as a single memory or multiple different memory devices (of the same type or of different types). The memory 106 is configured to store instructions 109, sensor data 130, one or more thresholds (collectively referred to herein as the “threshold 132”), and one or more operation parameters 134 (collectively referred to herein as the “operation parameter 134”). In some embodiments, the memory 106 is also configured to store media content, such as audio content.

In some examples, the memory 106 stores the instructions 109 that, when executed by the processor 108, cause the processor 108 to perform one or more operations as described herein. The sensor data 130 includes data generated or indicated by the sensor 110. The sensor data 130 may include temperature data, moisture data, power data, or a combination thereof, as illustrative, non-limiting examples. The threshold 132 includes or indicates one or more thresholds, such as one or more temperature thresholds, one or more moisture level thresholds, one or more power level thresholds, or a combination thereof, as illustrative, non-limiting examples. The threshold 132 may include a single value or a range of values. The threshold 132 may be set by a user or a manufacturer of the device, or by a network service provider.

In some embodiments, the threshold 132 includes an operational temperature range. The operational temperature range may comply with one or more safety regulations for consumer electronics. For example, the operation temperature range may be 20 °Celsius (C) to 42 °C, which is set to prevent overheating or injury to the user 190.

The operation parameter 134 may indicate one or more operational modes for the audio device 102. In some embodiments, the one or more operational modes may be associated with thermoregulation monitoring, a temperature control operation, a risk detection operation, or a combination thereof. For example, the one or more operational modes may include one or more preset modes, such as a first mode, a second mode, a third mode, or a combination thereof. Each of the first mode, the second mode, and the third mode may be associated with a different threshold (e.g., threshold 132), such as a different temperature threshold. For example, the first mode may be associated with a first temperature threshold range that includes 37 °C (e.g., 98.6 degrees Fahrenheit (F)), the second mode may be associated with a second temperature threshold range that includes 37 °C and is a larger range than the first temperature range threshold (e.g., the first temperature range threshold is a subset of the second temperature threshold range), and the third mode may be associated with a third temperature range that is includes temperatures greater than 37 °C. Additionally, or alternatively, at least one operational mode may be set or selected by the user 190. For example, the user 190 may set or select the at least one operation mode via the input device 114, the host device 180, or a combination thereof. When the at least one operational mode is set by the user 190, the at least one operational mode may be referred to as a manual mode.

The processor 108 is configured to perform data processing, to communicate with the host device 180 or another device, or a combination thereof. The processor 108 may include a central processing unit (CPU), a digital signal processor (DSP), one or more other types of processors, or a combination thereof.

The processor 108 is coupled to the microphone 104, the memory 106, the sensor 110, the speaker 112, the input device 114, the power supply 116, the heat element 120, the transceiver 118, or a combination thereof. The processor 108 includes a controller 140. The controller 140 is configured to perform thermoregulation monitoring, one or more temperature control operations (e.g., dynamic temperature regulation associated with the user 190), a risk detection operation, or a combination thereof, as further described herein. The controller 140 includes a comparator 142, a heat element controller 144, and a risk detector 146. The controller 140, or a portion thereof (e.g., the comparator 142, the heat element controller 144, or the risk detector 146), may be implemented by the processor 108 executing instructions (e.g., software), dedicated hardware (e.g., circuitry), a combination thereof.

The comparator 142 is configured to perform one or more comparisons and generate a result 160 for a respective comparison. For example, the comparator 142 may perform a comparison between, or based on, the sensor data 130 from two different sensors (e.g., the sensor 110) to generate the result 160. As another example, the comparator 142 may perform a comparison between, or based on, the sensor data 130 and the threshold 132 to generate the result 160.

The heat element controller 144 is configured to control operation of the heat element 120. For example, the heat element controller 144 may control the operation of the heat element 120 based on the sensor data 130, the threshold 132, the operation parameter 134, the result 160, input data 115 from the input device 114, an input from the host device 180, or a combination thereof. In some embodiments, to control the operation of the heat element 120, the heat element controller 144 is configured to adjust an amount of power (from the power supply 116) provided to the heat element 120. For example, to control the amount of power provided to the heat element 120, the heat element controller 144 may be configured to use pulse width modulation (PWM) to regulate a flow of current to the heat element 120 and thereby control an amount of heat generated by the heat element 120. The operation of the heat element 120 may provide one or more benefits, such as an ear hygiene benefit or improved comfort. For example, the regulated warmth provided by the heat element 120 may prevent wax buildup (e.g., excessive wax buildup), which is common in cold weather, and enable prolonged comfort and better ear health for the user 190 during extended use of the audio device 102.

The risk detector 146 is configured to detect or identify one or more risks associated with operation of the audio device 102. For example, the risk detector 146 may detect or identify the one or more risks based on the sensor data 130, the threshold 132, the operation parameter 134, the result 160, the input data 115 from the input device 114, an input from the host device 180, or a combination thereof. For example, the risk detector 146 may detect or identify that the audio device 102 has a temperature that exceeds the operational temperature range (e.g., a temperature risk), and responsive to detecting the risk, the risk detector 146 may shutdown the audio device 102, automatically disable operation of the heat element 120, generate a notification 162 that indicates the identified risk/issue and that is provided to the host device 180 or output via the speaker 112, or a combination thereof. As another example, the risk detector 146 may detect or identify health data (e.g., temperature data) or a health risk (e.g., onset of hypothermia) associated with the user 190. In some embodiments, the risk detector 146 can monitor a temperature (e.g., a body temperature) associated with the user and detect or identify prolonged drops in body temperature, which may indicate hypothermia. Based on the identified drop in body temperature, the risk detector 146 can generate the notification 162 that indicates the identified risk/issue and that is provided to the host device 180 or output via the speaker 112, or a combination thereof.

The sensor 110 is configured to generate or indicate the sensor data 130. In some embodiments, the sensor 110 includes a first temperature sensor 150, a second temperature sensor 152, a third temperature sensor 154, a moisture sensor 156, and a power sensor 158. The first temperature sensor 150 and the second temperature sensor 152 may be coupled to or incorporated in the housing 103. The third temperature sensor 154, the moisture sensor 156, and/or the power sensor 158 may be positioned in the cavity 105. Although the embodiment of the audio device 102 of FIG. 1 is shown as having five sensors, in other embodiments, the audio device 102 may include fewer than five or more than five sensors. For example, the audio device 102 may not include at least one the first temperature sensor 150, the second temperature sensor 152, the third temperature sensor 154, the moisture sensor 156, or the power sensor 158.

The first temperature sensor 150 is configured to generate first temperature data that indicates a body temperature of the user 190. For example, the first temperature sensor 150 may be coupled to the housing 103 such that the first temperature sensor 150 is configured to capture or detect a skin temperature of an ear 192 of the user 190 or an ear canal temperature of the user 190. In some embodiments, the first temperature sensor 150 includes one or more infrared sensors, such as a single infrared sensor or an array of infrared sensors, that are configured to measure the ear canal temperature non-invasively and in real-time. The one or more infrared sensors can be positioned on the housing 103 such that, when the audio device 102 is worn by the user 190, the first temperature sensor 150 is placed near the ear canal opening for accurate body temperature readings. In some such embodiments, the first temperature sensor 150 is arranged or located in a position to enable measurement of a temperature within an ear canal 195 of the user 190.

The second temperature sensor 152 is configured to generate second temperature data that indicates an ambient temperature associated with the audio device 102. In some embodiments, the second temperature sensor 152 includes one or more thermistors that are configured to measure an external temperature. The second temperature sensor 152 may be coupled to the housing 103 and, in some embodiments, may be positioned on an opposite side of the audio device 102 as compared to a side on which the first temperature sensor 150, the interface 122, and/or the speaker 112 are positioned.

The third temperature sensor 154 is configured to generate third temperature data that indicates a temperature in the cavity 105. The moisture sensor 156 is configured to generate moisture data that indicates a moisture level or a moisture content in the cavity 105.

The power sensor 158 is configured to monitor or determine a power level, a charging status (e.g., charging or non-charging), or both, of the power supply 116. The power sensor 158 may be configured to generate a power indicator that includes or indicates the power level of the power supply 116, the charging status (e.g., a charging state), or a combination thereof. In some implementations, the power sensor 158 is configured to transmit the power indicator to another component of the audio device 102, such as the processor 108 (e.g., the controller 140).

The speaker 112 is coupled to the processor 108 and configured to output audio sound 172. To illustrate, the audio sound 172 output by the speaker 112 may be based on audio content stored at the memory 106, received from the host device 180, or received from another device (e.g., a server). The audio sound 172 may correspond to music, a podcast, audio of a telephone call, audio associated with augmented reality (AR) content, virtual reality (VR) content, or extended reality (XR) content, audio associated with other multimedia content, noise cancellation, or a combination thereof.

The input device 114 is coupled to the processor 108 and is configured to receive an input, represented by the input data 115, from the user 190. The input device 114 may include a microphone, a keyboard, a touch screen, or another on-device touch-sensitive button, as illustrative, non-limiting examples. Alternatively, the processor 108 may be configured to receive the input data 115 from the host device 180.

The power supply 116 is configured to store and provide power to one or more components of the audio device 102. To illustrate, the power supply 116 may be coupled to, and configured to provide power to, the microphone 104, the memory 106, the processor 108, the sensor 110, the speaker 112, the transceiver 118, the heat element 120, or a combination thereof. In some implementations, the power supply 116, such as a battery, is configured to be re-chargeable. For example, the power supply 116 can be charged by being coupled to another power source, such as a power source that is external to the audio device 102.

Although the audio device 102 is described as including the power supply 116 and the power sensor 158, in other embodiments, the power supply 116, the power sensor 158, or both, are external to the audio device 102. For example, the power supply 116 can be external to the audio device 102 and coupled to the audio device 102.

The heat element 120 is configured to generate and radiate heat. In some embodiments, the heat element 120 includes graphene (e.g., a graphene heat element), carbon fiber (e.g., a carbon fiber heat element), or a combination thereof. The heat element 120 may be coupled to or integrated in one or more portions of the audio device 102. For example, the heat element may be coupled to or integrated in the housing 103. In some such examples, the heat element 120 may be, or may include, a thin, flexible layer within the housing 103 that warms the audio device 102 uniformly while maintaining a lightweight and compact design. Additionally, or alternatively, the heat element 120 may be positioned around a speaker housing of the speaker 112 to ensure heat transfer directly around the ear canal 195 while avoiding interference with sound quality. In some embodiments, the heat element 120 is included in the interface 122. For example, when the interface 122 of the audio device 102 is an ear tip configured for in-ear coupling (such as when the audio device 102 is an ear bud or a hearing aid), the interface 122 may include the heat element 120. For example, the interface that includes the heat element 120 may be a graphene-infused silicone or a memory foam tip that enables heat transfer directly to the ear canal, which may enhance user comfort and prevent earwax buildup. As another example, when the interface 122 is earcup padding (such as when the audio device 102 is a headset-e.g., an over-ear configuration), the heat element 120 may be embedded within the earcup padding and/or a headband of the audio device 102, which may promote heat transfer across the audio device 102.

The interface 122 is configured to couple the audio device 102 to the user 190. For example, the interface 122 may be configured to contact the user 190, such as by contacting skin of the user 190, the ear canal 195 of the user 190, or a combination thereof. In some embodiments, when the audio device 102 is an ear bud, a hearing aid, or an earplug, the interface 122 may be or include an ear tip configured for in-ear coupling. In some other embodiments, when the audio device 102 is a headset or earmuff-e.g., an over-ear configuration that covers the ear 192, the interface 122 may include an earcup, earcup padding, or a combination thereof. In some embodiments, the interface 122 includes a material, such as a hypoallergenic, heat-resistant material that is configured for efficient heat regulation and/or that reduces or prevents discomfort or skin irritation by the user 190. The material may include medical-grade silicone, TPU, polyimide, graphene, a foam, or a combination thereof, as illustrative, non-limiting examples.

The transceiver 118 is coupled to one or more components of the audio device 102. For example, the transceiver 118 may be coupled to the memory 106, the processor 108, or a combination thereof. The transceiver 118 is configured to enable communication between the audio device 102 and another device, such as the host device 180 and/or a network node, as illustrative, non-limiting examples. The transceiver 118 may include a modem, a transceiver (e.g., a transmitter and/or a receiver), an antenna, or a combination thereof. In some embodiments, the transceiver 118 includes a modem configured to send audio data, such as microphone audio data or processed microphone audio data, the input data 115, the sensor data 130, the result 160, the notification 162, or a combination thereof. Additionally, or alternatively, the transceiver 118 may be configured to receive audio data associated with the input data 115, the audio output data 164, the threshold 132, the operation parameters 134, or a combination thereof. In some examples, the transceiver 118 includes a Bluetooth (BT) interface, such as a BT advanced audio distribution profile (A2DP) interface, a BT human interface device (HID) interface, or a combination thereof. In other examples, the transceiver 118 includes a Wi-Fi interface, an IEEE 802.11 interface, a Zigbee interface, or another type of wireless interface.

The host device 180 is configured to be coupled (e.g., communicative coupled) to the audio device 102 and support operation of the audio device 102. It is noted that while the embodiment of the system 100 shown in FIG. 1 includes the host device 180, the host device 180 may be optional and, in other embodiments, the system 100 may not include the host device 180. The host device 180 may include a memory, one or more processors, a power source (e.g., a battery), and a wireless interface. The memory may include one or more memories, such as a single memory or multiple different memories (of the same type or of different types). The memory includes or is configured to store instructions that, when executed by the processor of the host device 180, cause the processor to perform one or more operations. The host device 180 also may include or be coupled to one or more other devices or components, such as a microphone, a speaker, a display device, an input device, or a combination thereof, as illustrative non-limiting examples. In such examples, the input device may include a microphone, a keyboard, or a touch screen, as illustrative, non-limiting examples.

In some embodiments, the host device 180 includes or stores software, such as an application, that is configured to operate with or control the audio device 102. The application may be configured to send data to or receive data from the audio device 102. For example, the user 190 may be able to control or provide the input data 115 to the audio device 102 via the host device 180.

In some embodiments, the host device 180 may also establish a communication session, such as a personal area network, with the audio device 102 to communicate with the audio device 102. Communication links of the personal area network may be 2.4 gigahertz (GHz), 5 GHz, or 6 GHz wireless communication links for reduced latency and/or high throughput applications, such as streaming audio for gaming applications, music, podcasts, audio books, or voice calls. Additionally, or alternatively, the host device 180 may communicate with a network node (e.g., an access point (AP)) in a wireless local area network (WLAN) via a channel, such as a 2.4 GHz (also referred to as 2 GHz), 5 GHz, or 6 GHz wireless communication link. For example, the channel may include or correspond to a cellular link or a wireless fidelity link.

The user 190, such as a person, may use or operate the audio device 102, the host device 180, or both. For example, the user 190 may wear the audio device 102 to listen to the audio sound 172 that is output by the audio device 102. As another example, the user 190 may wear the audio device 102 as a hearing protection device to decrease an intensity of sound that reaches an eardrum. The audio device 102 may be configured to be coupled to the ear 192 of the user 190. In some embodiments, the first temperature sensor 150 may determine a temperature of the user 190 at one or more locations or portions of the ear 192, such as a crus 194, the ear canal 195, a concha 196, an antihelix 197, a tragus 198, and an antitragus 199.

In some embodiments, the system 100 may communicate with or be configured to operate as part of a wireless communication system configured to implement a 5G NR network or a 6G network. For example, the system 100 may include multiple 5G-capable devices (or 6G-capable devices) and multiple 5G-capable network nodes (or 6G-capable network nodes), such as devices and network nodes configured to operate in accordance with a 5G NR network protocol, or a 6G network protocol, such as that defined by the 3GPP.

During operation of the system 100, the processor 108 receives sensor data, such as the sensor data 130 from the sensor 110. For example, the processor 108 (e.g., the controller 140) may receive, from the first temperature sensor 150, first sensor data that indicates a first temperature associated with the ear 192 of the user 190. The controller 140 (e.g., the comparator 142) may perform a comparison associated with the first temperature and a first threshold (e.g., one of the thresholds 132) to generate a first result (e.g., the result 160). In some examples, the first threshold is a threshold range and is a preset threshold or a threshold set by the user 190. Based on the first result, the heat element controller 144 may control heat generation of the heat element 120. For example, based on the first result indicating that the first temperature is less than a first threshold range (e.g., between 20 °C to 37 °C), the heat element controller 144 may activate the heat element 120 to generate heat. As another example, based on the first result indicating that the first temperature is greater than the first threshold range, the heat element controller 144 may deactivate the heat element 120. As another example, based on the first result indicating that the first temperature is within the first threshold range, the heat element controller 144 may deactivate the heat element 120 or maintain the heat element 120 in a deactivated state.

Additionally, or alternatively, the processor 108 (e.g., the controller 140) may receive, from the second temperature sensor 152, second sensor data that indicates an ambient temperature around the audio device 102. The controller 140 (e.g., the heat element controller 144) may control the heat generation of the heat element 120 further based on the ambient temperature. For example, the processor 108 (e.g., the comparator 142) may perform a comparison based on the ambient temperature and a second threshold (e.g., the threshold 132), or based on the ambient temperature and the first temperature, to generate a second result (e.g., the result 160). In some embodiments, based on the second result indicating that the ambient temperature is less than the second threshold and/or the first temperature, the heat element controller 144 may activate the heat element 120 if the heat element 120 is in a deactivated state.

In an illustrative example, the user 190 may be outside in a cold environment with an ambient temperature of-5 °C (23 °F). The first temperature sensor 150 may generate first sensor data that indicates a body temperature of the user 190 is 36.5 °C (97.7 °F). The second temperature sensor 152 may generate second sensor data that indicates the ambient temperature (e.g., the temperature of the cold environment). The processor 108 may receive the first sensor data and the second sensor data. In this example, based on the first sensor data, the controller 140 determines that the body temperature of the user 190 is within a first threshold range—e.g., the user's skin temperature is at a normal level. Additionally, based on the second sensor data (e.g., the cold environmental temperature), the controller 140 determines to activate the heat element 120 to generate heat to maintain a comfortable temperature for the ear canal 195. The cold environmental temperature may be less than the second threshold. Accordingly, the heat element controller 144 activates the heat element 120 (e.g., a graphene heating element) to increase the earbud temperature to 38 °C (100.4 °F), thereby preventing the user 190 from feeling the cold environmental temperature via the ear 192. The user 190 can experience a warm and comfortable fit of the audio device 102 with no discomfort or risk of the ear 192 freezing. The audio device 102 may maintain appropriate heating without overheating based on continued temperature monitoring using the first temperature sensor 150 and/or the second temperature sensor 152 and appropriate control of the heat element 120.

In another example, based on the second result indicating that the ambient temperature is greater than or equal to the second threshold and based on the first temperature being within the first temperature range, the heat element controller 144 may maintain the heat element 120 in a deactivated state or adjust the heat element 120 to the deactivated state. In this example, the user 190 may be indoors in a temperature-controlled environment having a temperature of 18 °C (64 °F). The first temperature sensor 150 may generate first sensor data that indicates a body temperature of the user 190 is 37 °C (98.6 °F). The second temperature sensor 152 may detect the ambient temperature and send second sensor data to the processor 108. The controller 140 determines that the body temperature of the user 190 is within a first threshold range e.g., the user's skin temperature is at the normal level. Based on the second sensor data (e.g., the indoor environmental temperature), the controller 140 determines that no additional heating is necessary. For example, the indoor environmental temperature may be greater than or equal to the second threshold. Accordingly, the audio device 102 does not activate the heat element 120, thereby saving power while keeping the user 190 comfortable. In some embodiments, the audio device 102 continues to monitor the body temperature of the user 190 and/or the ambient temperature to ensure that the user 190 does not get too warm or too cold. If the controller 140 detects that the audio device 102 or the user 190 is too hot, one or more safety features (e.g., turning on a cooling fan or a performing device shut-down operation) may be initiated to ensure the user's comfort and the longevity of the audio device 102.

In another example, the user 190 uses the audio device 102 in a relatively warm environment having an ambient temperature of 25 °C (77 °F). The first temperature sensor 150 may generate first sensor data that indicates a body temperature of the user 190 is 36.5 °C (97.7 °F). The second temperature sensor 152 may detect the ambient temperature and send second sensor data to the processor 108. The controller 140 determines that the body temperature of the user 190 is within a first threshold range e.g., the user's skin temperature is at the normal level. Based on the second sensor data, the controller 140 determines that no additional heating is necessary. The audio device 102 may continue to monitor the body temperature of the user 190 and/or the ambient temperature to ensure that the user 190 does not get too warm or too cold. If the controller 140 detects that a temperature of the audio device 102 is greater than or equal to a third threshold (e.g., 40 °C (104 °F)), the controller 140 may automatically cut off or reduce power to the heat element 120 to prevent overheating of the audio device 102. For example, the controller 140 may receive third temperature data that indicates the temperature of the audio device 102 from the third temperature sensor 154, and the controller 140 may automatically cut off or reduce power to the heat element 120 if the temperature of the audio device 102 is greater than or equal to the third threshold. By cutting off or reducing power to the heat element 120 when the temperature of the audio device 102 is sufficiently high, the user 190 is protected from excessive warmth in the ear 192, thereby maintaining comfort. Additionally, such overheating protection reduces the chances of or prevents the heat element 120 from reaching particular high temperatures, even if the external conditions change, and thereby operate the audio device 102 within safe limits.

In another example, the user 190 uses the audio device 102 in a severely cold environment with an ambient temperature of −10 °C (14 °F). The first temperature sensor 150 may generate first sensor data that indicates a body temperature of the user 190 is at 34.8 °C (94.6 °F), which may be an early indication of hypothermia. The second temperature sensor 152 may detect the ambient temperatures (e.g., the cold environmental temperature) and send second sensor data to the processor 108. The controller 140 determines that the body temperature of the user 190 is less than or equal to a fourth threshold (e.g., the threshold 132), such as a hypothermia alert threshold. Based on the first sensor data (e.g., the body temperature), the controller 140 (e.g., the risk detector 146) determines to generate the notification 162 that is provided to the user 190 via the speaker 112 and/or is transmitted to the host device 180. The notification 162 may indicate for the user 190 to seek warmth immediately. Additionally, or alternatively, based on the first sensor data (e.g., the body temperature), the controller 140 (e.g., the heat element controller 144) determines to activate the heat element 120. Thus, the audio device 102 provides added warmth to the user's ear area and provides the notification 162 (e.g., a hypothermia alert) to warn the user 190 to take immediate action.

In another example, the processor 108 (e.g., the controller 140) receives, from the moisture sensor 156, moisture sensor data that indicates an amount of moisture in the cavity 105. The controller 140 (e.g., the heat element controller 144) may control the heat generation of the heat element 120 further based on the amount of moisture in the cavity 105. The processor 108 (e.g., the comparator 142) may perform a comparison based on the amount of moisture in the cavity 105 and a moisture threshold (e.g., the threshold 132). Based on the amount of moisture in the cavity 105 being greater than or equal to the moisture threshold, the heat element controller 144 may activate the heat element 120. Alternatively, based on the amount of moisture in the cavity 105 being less than the moisture threshold, the heat element controller 144 may deactivate the heat element 120.

In some embodiments, an audio device (e.g., the audio device 102) includes a first temperature sensor (e.g., the first temperature sensor 150) configured to generate first sensor data (e.g., the sensor data 130) that indicates a first temperature associated with an ear (e.g., the ear 192) of a user (e.g., the user 190), and a heat element (e.g., the heat element 120) configured to generate heat. The audio device further includes one or more processors (e.g., the processor 108) configured to receive the first sensor data from the first temperature sensor, and control the heat element based on a result (e.g., the result 160) of a comparison associated with the first temperature and a threshold (e.g., the threshold 132).

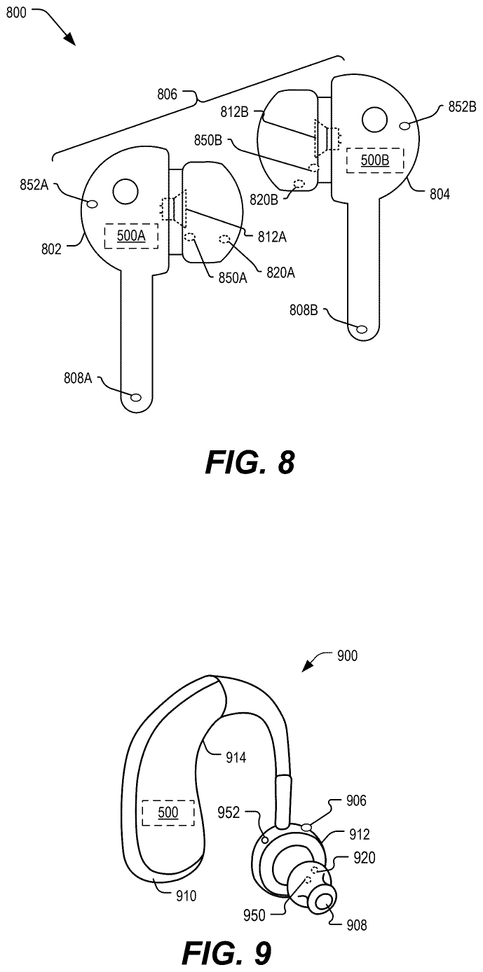

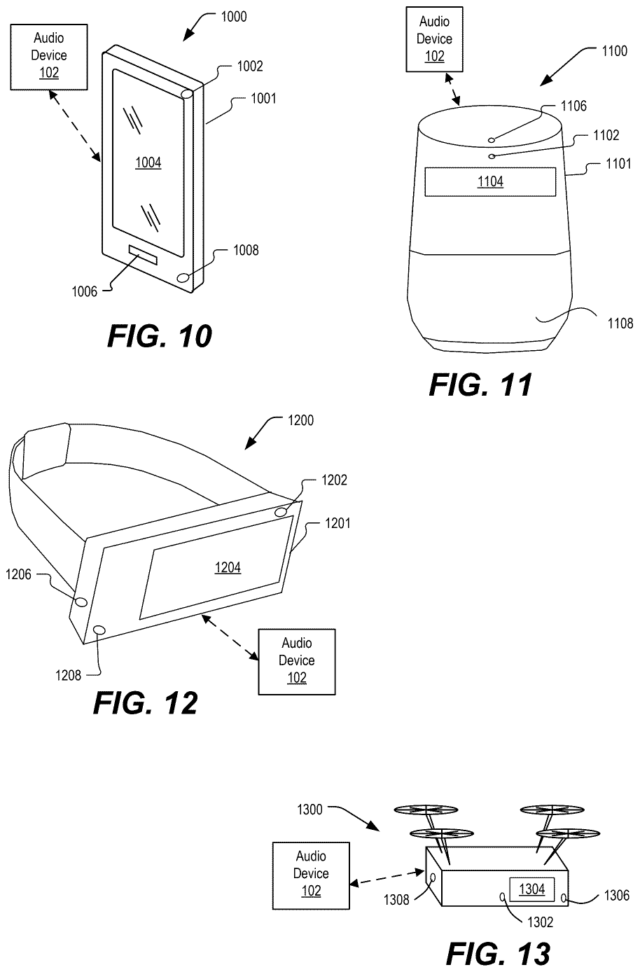

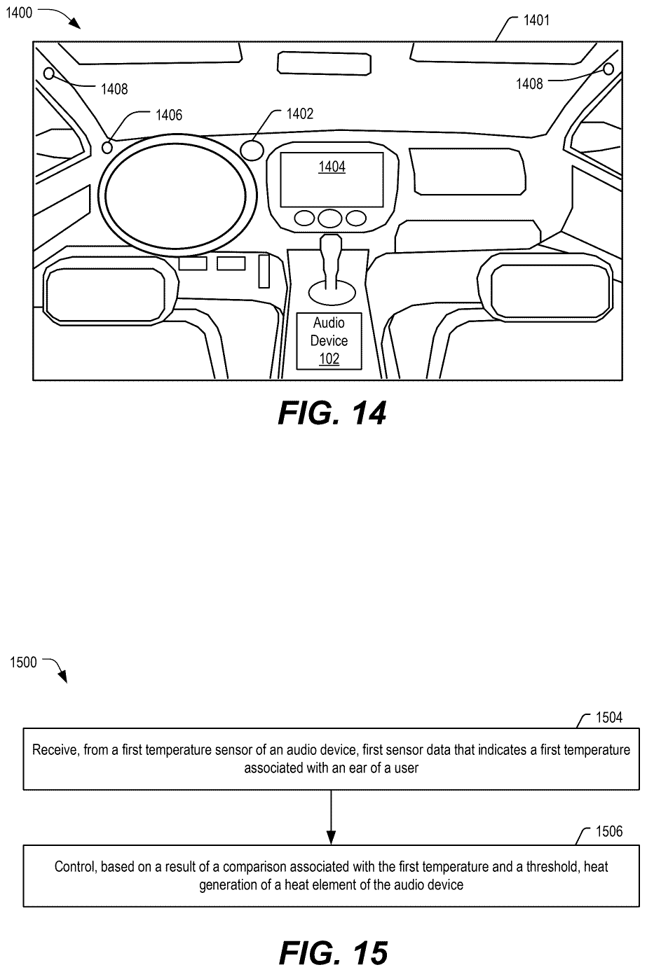

In some examples, the audio device 102 corresponds to or is included in one of various types of devices, such that the processor 108 can be integrated in multiple types of devices. In an illustrative example, the processor 108 is integrated in a wearable device, such as a headset as depicted in FIG. 6, a virtual reality, mixed reality, or augmented reality headset as depicted in FIG. 7, earbuds as described with reference to FIG. 8, a hearing aid device as described with reference to FIG. 9, a hearing protection device (e.g., an earplug or a pair of earplugs, or earmuffs), or another wearable device. In another illustrative example, the host device 180 is integrated in or includes a mobile device (a mobile phone or a tablet) as depicted in FIG. 10, a voice-controlled speaker system as depicted in FIG. 11, a wearable electronic device as depicted in FIG. 12, a vehicle as depicted in FIG. 13 or FIG. 14, a computer (e.g., a desktop computer or a laptop computer) or a server, a television, or another system or device.

One technical advantage of implementing the audio device 102 as described above is that the audio device 102 can provide adaptive temperature control. In some aspects, the audio device 102 can perform the adaptive temperature control based on body temperature data associated with thermoregulation of the user 190, and the adaptive temperature control can provide comfort or warmth to the user 190, maintain or promote ear hygiene (e.g., minimize wax accumulation in the ear canal 195), or a combination thereof. Additionally, or alternatively, the audio device 102 may provide health monitoring associated with the user 190, such as identification of an uncomfortable or hazardous condition (e.g., hypothermia) and generation of the notification 162. In other aspects, the audio device 102 is configured to perform the adaptive temperature control based on an environmental condition, such as an ambient temperature, which can provide comfort or warmth to the user 190 when the audio device 102 is used in a cold weather or freezing conditions. In some aspects, the audio device 102 maintains a device temperature (e.g., a heat level) that prevents overheating or underheating and that satisfies one or more safety standards or criteria. In some aspects, the audio device 102 can prevent moisture-related damage and maintain consistent performance in unpleasant environmental conditions, such as wet conditions, hot conditions, or cold conditions. Accordingly, the adaptive temperature control performed by the audio device 102 can enhance comfort and durability of the audio device 102 while also promoting health and safety of the user 190 of the audio device 102.

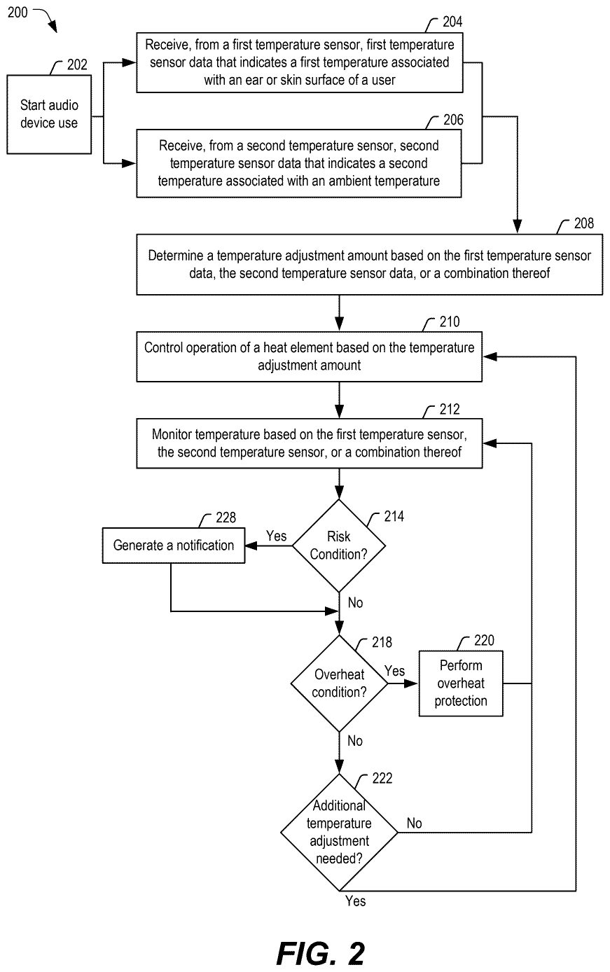

FIG. 2 is a diagram of an example of a method 200 associated with the system 100 of FIG. 1, in accordance with some aspects of the present disclosure. In a particular aspect, one or more operations of the method 200 are performed by the system 100, the audio device 102, the processor 108, the controller 140 or a portion of the controller 140, or a combination thereof.

In some embodiments, the method 200 includes, at block 202, starting use of an audio device. For example, the audio device may include or correspond to the audio device 102.

At block 204, the method 200 includes receiving, from the first temperature sensor, first temperature sensor data that indicates a first temperature associated with an ear or skin surface of a user of the audio device. For example, the first temperature sensor and the user may include or correspond to the first temperature sensor 150 and the user 190, respectively. In some embodiments, the first temperature sensor includes an infrared sensor configure to detect or measure a body temperature by monitoring the temperature near the ear or skin surface. The method 200 then advances to block 208, as further described herein.

At block 206, the method 200 includes receiving, from a second temperature sensor, second temperature sensor data that indicates a second temperature associated with an ambient temperature (with respect to the audio device). For example, the second temperature sensor may include or correspond to the second temperature sensor 152. In some embodiments, the second temperature sensor includes an external ambient temperature sensor, such as a thermistor, that is configured to detect or measure the temperature of the environment, such as air temperature. The method 200 then advances to block 208, as further described herein.

At block 208, the method 200 includes determining a temperature adjustment amount based on the first temperature sensor data, the second temperature sensor data, or a combination thereof. For example, the temperature adjustment amount may be determined by the controller 140, the comparator 142, the heat element controller 144, or a combination thereof. In some embodiments, the temperature adjustment amount is determined or calculated based on a pre-programmed threshold and/or algorithms.

At block 210, the method 200 includes controlling operation of a heat element based on the temperature adjustment amount. For example, the heat element may include or correspond to the heat element 120, such as a graphene heat element, a carbon fiber heat element, or a combination thereof. Controlling the operation of the heat element may include sending a signal to the heating element. For example, the heat element may be controlled or activated using a PWM signal to control an amount of current provided to the heat element and thereby control an amount of heat generated by the heat element. The heat element may generate heat which is transferred from the audio device to adjust a temperature of an ear of the user.

At block 212, the method 200 includes monitoring one or more temperatures based on the first temperature sensor, the second temperature sensor, or a combination thereof. At block 214, the method 200 includes determining whether a risk condition is present. In some embodiments, the risk condition is determined to be present based on a body temperature of the user being less than or equal to a low temperature threshold, which may indicate or be associated with onset of hypothermia. In some embodiments, one or more determinations at block 214 may be made based on the one or more temperatures monitored at block 212.

Based on a determination that the risk condition is present, the method 200 advances to block 228, which includes generating a notification. For example, the notification may include or correspond to the notification 162. In some examples, the notification is sent to the user via the audio device or via a host device, such as the host device 180. After generation of the notification at block 228, the method 200 advances to block 218. Alternatively, based on a determination that no risk condition is present at block 214, the method 200 advances to block 218.

At block 218, the method 200 includes determining whether an overheat condition is present. For example, the overheat condition may be determined based on sensor data received from the first temperature sensor, a third temperature sensor, or a combination thereof. The third temperature sensor may include or correspond to the third temperature sensor 154. In some aspects, the audio device 102 may continuously monitor one or more temperatures in real-time or near-real time using feedback from the sensors to ensure that the audio device stays within the safe operating range. Based on a determination that the overheat condition is present, the method 200 advances to block 220, which includes performing an overheat protection operation. For example, if a temperature from the first temperature sensor or the third temperature sensor is greater than or equal to a safety limit threshold, such as 40-45 °C, an overheat protection operation is triggered. The overheat protection operation may include automatically shutting off or reducing power to the heat element to prevent overheating of the audio device 102. After performance of the overheat protection operation, the method returns to block 212 to continue to monitor the one or more temperatures. Alternatively, based on a determination at block 218 that the overheat condition is not present, the method 200 advances to block 222.

At the block 222, the method 200 includes determining whether to perform additional temperature adjustment. In some embodiments, one or more determinations at block 222 may be made based on the one or more temperatures monitored at block 212. To illustrate, throughout usage of the audio device, the first temperature sensor (e.g., the infrared sensor) monitors the temperature near the ear canal of the user. If the temperature monitored by the first temperature sensor deviates from an acceptable threshold range, operation (e.g., a heat output) of the heat element 120 may be adjusted to maintain user comfort. In some embodiments where the audio device includes a pair of earbuds, a heat element of each earbud of the pair of earbuds may be controlled or adjusted independent of the other earbud of the pair of earbuds based on respective first temperature sensors in each of the earbuds. Based on a determination to not perform additional temperature adjustment, the method 200 returns to block 220 to continue to monitor the one or more temperatures. Alternatively, based on a determination to perform additional temperature adjustment, the method 200 returns to block 210 to perform a control operation for the heat element based on the additional temperature adjustment.

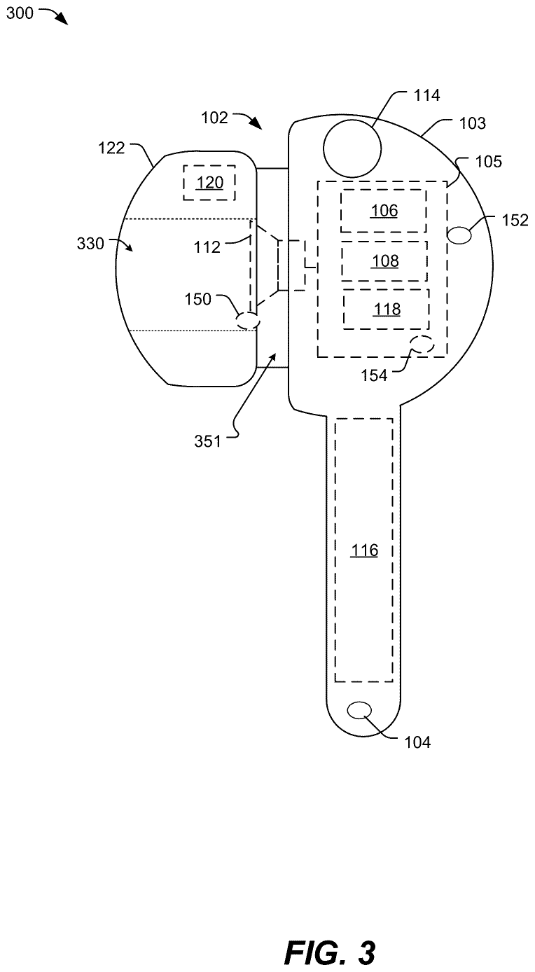

FIGS. 3 and 4 are diagrams of examples of the audio device of FIG. 1, in accordance with some examples of the present disclosure. FIG. 3 is a diagram of an example 300 of the audio device 102 in which the audio device 102 is an in-ear audio device, such as an earbud or a hearing aid, and FIG. 4 is a diagram of an example 400 of the audio device 102 in which the audio device 102 is an on-ear or over-ear audio device, such as a headset. In FIGS. 3 and 4, components of the audio device 102 that are integrated in the audio device 102 are illustrated using dashed lines to indicate internal components that are not generally visible to a user of the audio device 102.

In the examples 300 and 400, the audio device 102 each include the housing 103 that defines the cavity 105, the microphone 104, the memory 106, the processor 108, the speaker 112, the input device 114, the power supply 116, the transceiver 118, the heat element 120, and the interface 122. The memory 106 may include the instructions 109, the sensor data 130, the threshold 132, the operation parameter 134, or a combination thereof. The processor 108 includes the controller 140, which may include the comparator 142, the heat element controller 144, the risk detector 146, or a combination thereof. In the examples 300 and 400, the audio device 102 also include one or more sensors, such as the first temperature sensor 150, the second temperature sensor 152, and the third temperature sensor 154. In some embodiments, the one or more sensors may also include the moisture sensor 156, the power sensor 158, or a combination thereof, which are not shown in FIGS. 3 and 4.

In the example 300 depicted in FIG. 3, the interface 122 of the audio device 102 is an ear tip configured for in-ear coupling of the audio device 102 with the user 190. The interface 122 may include a graphene-infused silicone or memory foam tip that enables heat transfer directly to the ear canal, which may enhance user comfort and prevent earwax buildup for the user 190. The interface 122 includes a through channel 330 that directs audio output by the speaker 112 toward the ear 192 of the user 190 when the audio device 102 is coupled in-ear with the user 190.

In the example 300 of FIG. 3, the heat element 120 is included in the interface 122. Although the heat element 120 is described as being included in the interface 122, in other embodiments, the heat element 120 is not included in the interface 122 and may be integrated in or positioned on the housing 103, positioned in the cavity 105, or a combination thereof.

The first temperature sensor 150 is positioned to enable the first temperature sensor 150 to measure a body temperature of the user 190. For example, the first temperature sensor 150 may include an infrared sensor that is positioned to measure the body temperature of the ear canal 195 of the user 190. To illustrate, the first temperature sensor 150 can be positioned to enable an infrared measurement of the ear canal 195 via the through channel 330 of the interface 122. Additionally, or alternatively, the first temperature sensor 150 may be positioned on a surface 351 of the audio device 102. When the first temperature sensor 150 is positioned on the surface 351, the first temperature sensor 150 may measure the measure the body temperature of the ear canal 195 of the user 190 (and does note measure the body temperature via the through channel 330 of the interface 122) while the audio device 102 is coupled in-ear with the user 190.

In the example 400 of FIG. 4, the audio device 102 includes a headset having one or more earcups 401 (collectively referred to herein as “the earcup 401”) and a headband 420. In the example 400 of FIG. 4, the audio device 102 includes two earcups 401, such as a first earcup 401A and a second earcup 401B; however, in other embodiments, the audio device 102 may include a single earcup 401.

The headband 420 includes or is coupled to the microphone 104, the input device 114, the power supply 116, the transceiver 118, and the second temperature sensor 152. Each earcup 401 respectively includes a housing 103 that defines a cavity 105, a memory 106, a processor 108, a speaker 112, a heat element 120, an interface 122, a first temperature sensor 150, and a third temperature sensor 154. In other embodiments, only one of the earcups 401 includes a memory 106 and a processor 108, and that earcup is configured to receive sensor data from sensors of both earcups 401 and to independent control the heat elements 120 at each earcup. The interface 122 of the audio device 102 includes earcup padding and the heat element 120 may be included or incorporated (e.g., embedded) in the earcup padding. Additionally, or alternatively, the heat element 120 may be included in or coupled to the headband 420.

In some embodiments, referring to the first earcup 401A, the first temperature sensor 150 of the first earcup 401A is positioned to enable the first temperature sensor 150 to measure a body temperature of the respective ear canal 195 of the user 190 of the audio device. For example, the first temperature sensor 150 may include an infrared sensor, or an array of infrared sensors, that is positioned on the first earcup 401A to enable the first temperature sensor 150 to measure the body temperature of the ear canal 195 of the user 190. In some embodiments, the first earcup 401A may include multiple arrays of infrared sensors that are positioned at different locations and different orientations on the first earcup 401A. For example, each array may be positioned and oriented to enable the respective array to measure the body temperature of the ear canal 195. It is noted that the second earcup 401B may be configured and/or may operate as described with reference to the first earcup 401A.

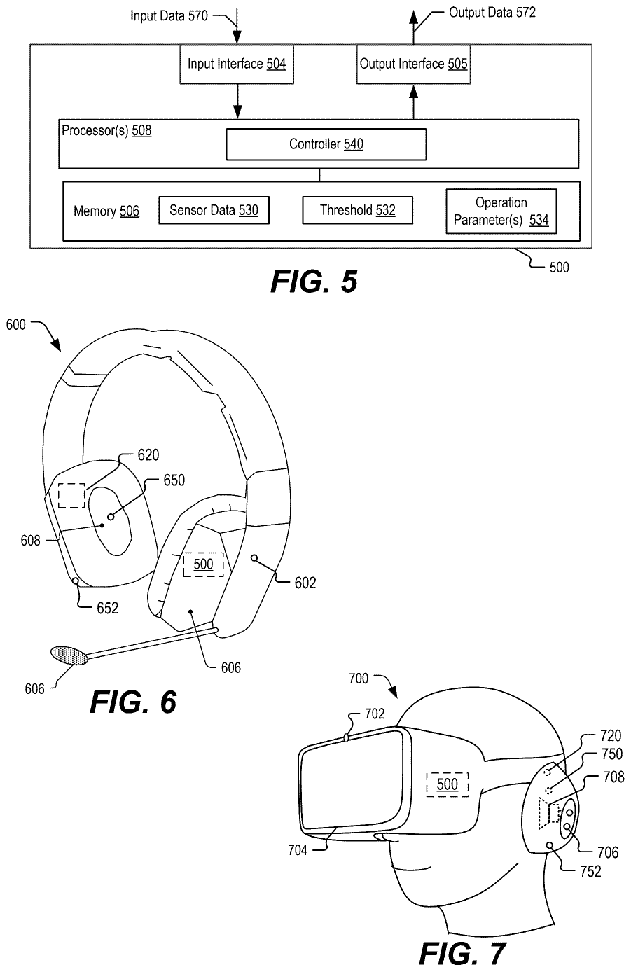

FIG. 5 depicts a diagram of an example of an integrated circuit 500 operable to provide adaptive temperature control, in accordance with some examples of the present disclosure. The integrated circuit 500 includes one or more processors 508 (herein after referred to as the “processor 508”) and a memory 506. The processor 508 and the memory 506 may include or correspond to the processor 108 and the memory 106, respectively. The processor 508 may include a controller 540. The controller 540 may include or correspond to the controller 140. In some embodiments, the controller 540 includes the comparator 142, the heat element controller 144, the risk detector 146, or a combination thereof. The memory 506 includes (e.g., stores) sensor data 530, a threshold 532, and one or more operation parameters 534. The sensor data 530, the threshold 532, and the one or more operation parameters 534 may include or correspond to the sensor data 130, the threshold 132, and the operation parameter 134, respectively. Although the memory 506 is described as including each of the sensor data 530, a threshold 532, and one or more operation parameters 534, in other embodiments, the memory 506 may not include at least one of the sensor data 530, the threshold 532, or the one or more operation parameters 534. Additionally, or alternatively, although the integrated circuit 500 is described as including the memory 506, in some other embodiments, the integrated circuit 500 does not include the memory 506.

The integrated circuit 500 also includes an input interface 504, such as one or more bus interfaces, to enable the integrated circuit 500 to receive signals representing input data 570 for processing. For example, the input data 570 can correspond to or include the instructions 109, the sensor data 130 or 530, the threshold 132 or 532, the operation parameter 134 or 534, the input data 115, the audio output data 164, the sound 170, or a combination thereof.

The integrated circuit 500 also includes an output interface 505, such as a bus interface, to enable the integrated circuit 500 to output signals representing output data 572. For example, the output data 572 can correspond to or include the sensor data 130 or 530, the threshold 132 or 532, the operation parameter 134 or 534, the input data 115, the result 160, the notification 162, the audio output data 164, the sound 170, a PWM signal (e.g., a control signal for a heat element), or a combination thereof.

The integrated circuit 500 including the controller 540 enables implementation of adaptive temperature control as a component in a system or a device. For example, the system or the device may include a headset as depicted in FIG. 6, a virtual reality, mixed reality, or augmented reality headset as depicted in FIG. 7, earbuds, as described with reference to FIG. 8, or a hearing aid device, as described with reference to FIG. 9. The integrated circuit 500 may be configured to be communicatively coupled to a host device, such as the host device 180. Additionally, or alternatively, the host device may include or correspond to a mobile device (e.g., a mobile phone or tablet) as depicted in FIG. 10, a voice-controlled speaker system as depicted in FIG. 11, a wearable electronic device as depicted in FIG. 12, or a vehicle as depicted in FIG. 13 or FIG. 14.

In some embodiments, the system or the device that includes the integrated circuit 500 also includes or is coupled to an input device (e.g., a microphone, a keyboard or touch screen, etc.), a microphone, a speaker, a transceiver (e.g., a modem), or a combination thereof. For example, the input device, the microphone, the speaker, and the interface may include or correspond to the input device 114, the microphone 104, the speaker 112, and the transceiver 118, respectively. Additionally, or alternatively, the system or the device that includes the integrated circuit 500 also includes or is coupled to an image sensor (e.g., a camera), a display device, a modem, or a combination thereof.

In some embodiments, the system or the device that includes the integrated circuit 500 is operable to provide adaptive temperature control associated with the system or the device. For example, the controller 540 is configured to obtain first sensor data from the sensor data 530 that indicates a first temperature associated with an ear of a user of an audio device that includes a speaker configured to output audio to the ear of the user. The user, the audio device, and the speaker may include or correspond to the user 190, the audio device 102, and the speaker 112, respectively. The controller 540 is further configured to perform a comparison associated with the first temperature and the threshold 532, and control a heat element, such as the heat element 120, of the audio device based on a result of the comparison. For example, the controller 540 may control the heat element based on the sensor data 530 indicating that a body temperature of the user is outside of a threshold range. In a particular example, the controller 540 may control the heat element based on the body temperature of the user being less than or equal to a hypothermia alert threshold, and in such an example, the controller 140 may generate a notification that indicates for the user to seek warmth. Additionally, or alternatively, the controller 540 may control the heat element based on the sensor data 530 indicating that an ambient temperature associated with the audio device is less than or equal to a low environment temperature threshold. In some examples, the controller 540 may control the heat element to be deactivated based on a device temperature of the audio device being greater than or equal to an overheat threshold. In some embodiments, the controller 540 may control the heat element based on an amount of moisture being greater than or equal to a moisture content threshold.

FIG. 6 depicts a diagram of a headset device 600 operable to provide adaptive temperature control, in accordance with some examples of the present disclosure. The headset device 600 includes a camera 602 (e.g., an image sensor), one or more microphones 606, and one or more speakers 608. The headset device 600 also includes a heat element 620 and one or more sensors, such as a first temperature sensor 650, and a second temperature sensor 652. Components of the headset device 600, including the integrated circuit 500, are integrated in the headset device 600 and are illustrated using dashed lines to indicate internal components that are not generally visible to a user of the headset device 600.

FIG. 7 is a diagram of a headset 700, such as a virtual reality, mixed reality, or augmented reality headset, operable to provide adaptive temperature control, in accordance with some examples of the present disclosure. A visual interface device is positioned in front of the user's eyes to enable display of augmented reality, mixed reality, or virtual reality images or scenes to the user while the headset 700 is worn. The headset 700 also includes a camera 702 (e.g., an image sensor), a display 704 (e.g., a display screen), a microphone 706, a speaker 708, and the integrated circuit 500. The headset 700 also includes a heat element 720 and one or more sensors, such as a first temperature sensor 750, and a second temperature sensor 752. Components of the headset 700, including the integrated circuit 500, are integrated in the headset 700 and are illustrated using dashed lines to indicate internal components that are not generally visible to a user of the headset 700.

FIG. 8 illustrates a portable electronic device 800 that corresponds to a pair of earbuds 806 operable to provide adaptive temperature control, in accordance with some examples of the present disclosure. FIG. 8 depicts an embodiment in which the pair of earbuds 806 includes a first earbud 802 and a second earbud 804. Although earbuds are described, it should be understood that the present technology can be applied to other in-ear or over-ear audio devices.

Each of the first earbud 802 and the second earbud 804 includes a respective microphone 808. In some embodiments, the microphone 808 includes multiple microphones, such as a high signal-to-noise microphone positioned to capture the voice of a wearer of the first earbud 802, an array of one or more other microphones configured to detect ambient sounds and spatially distributed to support beamforming, an “inner” microphone proximate to the wearer's ear canal (e.g., to assist with active noise cancelling), and/or a self-speech microphone, such as a bone conduction microphone configured to convert sound vibrations of the wearer's ear bone or skull into an audio signal.

Each of the first earbud 802 and the second earbud 804 also includes a speaker 812, the integrated circuit 500, a heat element 820, and one or more sensors, such as a first temperature sensor 850, and a second temperature sensor 852. Components of each of the first earbud 802 and the second earbud 804, including the integrated circuit 500, that are integrated in the respective earbud are illustrated using dashed lines to indicate internal components that are not generally visible to a user of the respective earbud.

In some implementations, the first earbud 802 is also configured to receive one or more audio signals generated by one or more microphones of the second earbud 804, such as via wireless transmission between the earbuds 802, 804, or via wired transmission in implementations in which the earbuds 802, 804 are coupled via a transmission line.

FIG. 9 illustrates a hearing aid device 900 operable to provide adaptive temperature control, in accordance with some examples of the present disclosure. In FIG. 9, the hearing aid device 900 includes a housing 910 including an over-ear portion 914 configured to be worn over the ear of a user. An earpiece 912 is coupled to the housing 910 and includes one or more speakers 908. In some embodiments, one or more microphones 906 are disposed on the housing 910. The hearing aid device 900 also includes the integrated circuit 500, a heat element 920, and one or more sensors, such as a first temperature sensor 950 and a second temperature sensor 952. Components of the hearing aid device 900, including the integrated circuit 500, are integrated in the hearing aid device 900 and are illustrated using dashed lines to indicate internal components that are not generally visible to a user of the hearing aid device 900.

In a particular example of one or more of the devices of FIGS. 6-9, the integrated circuit 500 (e.g., the processor 508 and/or the memory 506) is operable to provide adaptive temperature control. To illustrate, the processor 508 (e.g., the controller 540) of the integrated circuit is configured to obtain first sensor data from the first temperature sensor 650, 750, 850, or 950 that indicates a first temperature associated with an ear of a user of an audio device. The controller 540 is further configured to perform a comparison associated with the first temperature and a threshold, and control the heat element 620, 720, 820, or 920 based on a result of the comparison. For example, the controller 540 may control the heat element 620, 720, 820, or 920 based on a body temperature of the user being outside of a threshold range. In a particular example, the controller 540 may control the heat element 620, 720, 820, or 920 based on the body temperature of the user being less than or equal to a hypothermia alert threshold, and in such an example, the controller 140 may generate a notification that indicates for the user to seek warmth. Additionally, or alternatively, the controller 540 may control the heat element 620, 720, 820, or 920 based on sensor data from the second temperature sensor 652, 752, 852, or 952 that indicates an ambient temperature associated with the audio device being less than or equal to a low environment temperature threshold. In some examples, the controller 540 may control the heat element 620, 720, 820, or 920 to be deactivated based on a device temperature of the audio device being greater than or equal to an overheat threshold. In some embodiments, the controller 540 may control the heat element 620, 720, 820, or 920 based on an amount of moisture being greater than or equal to a moisture content threshold.

The embodiments of the systems or devices as described with reference to FIGS. 6-9 are described, respectively, as including a microphone, a speaker, a first temperature sensor, a second temperature sensor, a heat element, or a combination thereof. As described with reference to FIGS. 6-9, the microphone, the speaker, a first temperature sensor, a second temperature sensor, and a heat element may include or correspond to the microphone 104, the speaker 117, the first temperature sensor 150, the second temperature sensor 152, and the heat element 120, respectively. It is noted that in other embodiments of the systems or devices of FIGS. 6-9, one or more of the systems or devices of FIGS. 6-9 may not include the microphone. It is also noted that in some embodiments of the systems or devices of FIGS. 6 and 8 not include the speaker and/or may be configured as a hearing protection device. Additionally, or alternatively, one or more of the systems or devices of FIGS. 6-9 may include an additional component. For example, the additional component may include a third temperature sensor (e.g., the temperature sensor 154), an interface (e.g., the interface 122), and/or a transceiver (e.g., a modem), such as the transceiver 118.

FIGS. 10-14 depicts diagrams systems that include the audio device 102 of FIG. 1 communicative coupled to a respective host device, in accordance with some examples of the present disclosure. The host device may include or correspond to the host device 180.

FIG. 10 depicts a diagram of a system 1000 that includes a mobile device 1001 and the audio device 102. The mobile device 1001 may include or correspond to the host device 180 and is operable to support the audio device 102 configured to provide adaptive temperature control. The mobile device 1001 may include or correspond to a phone or a tablet, as illustrative, non-limiting examples. The mobile device 1001 includes a camera 1002 (e.g., an image sensor), a display 1004 (e.g., a display screen), a microphone 1006, a speaker 1008, a processor, a memory, and a transceiver. The mobile device 1001 is configured to be communicatively coupled with the audio device 102 such that the mobile device 1001 can send data to and received data from the audio device 102. For example, the mobile device 1001 may send the input data 115 to the audio device 102, and may receive the sensor data 130, the result 160, or the notification 162 from the audio device 102.

FIG. 11 is a diagram of a system that includes a voice-controlled speaker system 1101 and the audio device 102. The voice-controlled speaker system 1101 may include or correspond to the host device 180 and operable to support the audio device 102 configured to provide adaptive temperature control. The voice-controlled speaker system 1101 may include or correspond to a wireless speaker and voice activated device, as an illustrative, non-limiting example. The voice-controlled speaker system 1101 can have wireless network connectivity and is configured to execute an assistant operation. The voice-controlled speaker system 1100 includes a camera 1102 (e.g., an image sensor), a display 1104 (e.g., a display screen), a microphone 1106, a speaker 1108, a processor, a memory, and a transceiver. The voice-controlled speaker system 1101 is configured to be communicatively coupled with the audio device 102 such that the voice-controlled speaker system 1101 can send data to and received data from the audio device 102. For example, the voice-controlled speaker system 1101may send the input data 115 to the audio device 102, and may receive the sensor data 130, the result 160, or the notification 162 from the audio device 102.

FIG. 12 depicts a diagram of a system that includes a wearable electronic device 1201 and the audio device 102. The wearable electronic device 1201 may include or correspond to the host device 180 and operable to support the audio device 102 configured to provide adaptive temperature control. The wearable electronic device 1201 may include or correspond to a “smart watch,” as an illustrative, non-limiting example. The wearable electronic device 1201 includes a camera 1202 (e.g., an image sensor), a display 1204 (e.g., a display screen), a microphone 1206, a speaker 1208, a processor, a memory, and a transceiver. The wearable electronic device 1201 is configured to be communicatively coupled with the audio device 102 such that the wearable electronic device 1201 can send data to and received data from the audio device 102. For example, the wearable electronic device 1201 may send the input data 115 to the audio device 102, and may receive the sensor data 130, the result 160, or the notification 162 from the audio device 102.

FIG. 13 is a diagram of a system that includes a first example of a vehicle 1301 and the audio device 102. The vehicle 1301 may include or correspond to the host device 180 and operable to support the audio device 102 configured to provide adaptive temperature control. The vehicle 1301 may include or correspond to a manned or unmanned aerial device (e.g., a package delivery drone). The vehicle 1301 includes a camera 1302 (e.g., an image sensor), a display 1304 (e.g., a display screen), a microphone 1306, a speaker 1308, a processor, a memory, and a transceiver. The vehicle 1301 is configured to be communicatively coupled with the audio device 102 such that the vehicle 1301 can send data to and received data from the audio device 102. For example, the vehicle 1301 may send the input data 115 to the audio device 102, and may receive the sensor data 130, the result 160, or the notification 162 from the audio device 102.

FIG. 14 is a diagram of a system that includes a second example of a vehicle 1401 and the audio device 102. The vehicle 1401 may include or correspond to the host device 180 and operable to support the audio device 102 configured to provide adaptive temperature control. The vehicle 141 may include or correspond to a car. The vehicle 1401 includes a camera 1402 (e.g., an image sensor), a display 1404 (e.g., a display screen), a microphone 1406, one or more speakers 1408, a processor, a memory, and a transceiver. The vehicle 1401 is configured to be communicatively coupled with the audio device 102 such that the vehicle 1401 can send data to and received data from the audio device 102. For example, the vehicle 1401 may send the input data 115 to the audio device 102, and may receive the sensor data 130, the result 160, or the notification 162 from the audio device 102.

Although the examples of the vehicle of FIGS. 13 and 14 are describe an aerial device and a car, respectively, in other examples, the vehicle can correspond to an aircraft (such as a fixed wing aircraft, a rotary wing aircraft, an aerostat, a hybrid aircraft, spaceship, or another type of aircraft), a land craft (such as a car, a truck, or another type of land craft), or a watercraft (such as a boat, a submersible, a ship, a barge, a ferry, or another type of watercraft). Further, the watercraft, the aircraft, the land craft, or watercraft can be manned or unmanned (e.g., crewed or uncrewed).

FIG. 15 is a diagram of an example of a method 1500 of providing adaptive temperature control, in accordance with some aspects of the present disclosure. In a particular aspect, one or more operations of the method 1500 are performed by the system 100, the audio device 102, the processor 108 or 508, the controller 140 or 540, the heat element controller 144, the integrated circuit 500, the headset device 600, the headset 700, the portable electronic device 800, the hearing aid device 900, or a combination thereof.

In some embodiments, the method 1500 includes, at block 1504, receiving, from a first temperature sensor of an audio device, first sensor data that indicates a first temperature associated with an ear of a user. The audio device may include or correspond to the audio device 102, the headset device 600, the headset 700, the portable electronic device 800, the hearing aid device 900, or a hearing protection device. The first temperature sensor may include or correspond to the sensor 110 or the first temperature sensor 150, 650, 750, 850, or 950. The first sensor data may include or correspond to the sensor data 130. In some embodiments, the first sensor data is received periodically from the first temperature sensor. Additionally, or alternatively, the first temperature sensor includes an infrared sensor that is configured to measure the temperature of an outer portion of the ear, an ear canal (e.g., the ear canal 195) of the user, or a combination thereof.

In some embodiments, the audio device includes a housing that defines a cavity. For example, the housing and the cavity may include or correspond to the housing 103 and the cavity 105. The audio device may also include an interface is coupled to the housing. For example, the interface may include or correspond to the interface 122. The interface can include an ear tip configured to be positioned within an ear canal of the user or padding of an over-ear earcup. The ear and the user may include or correspond to the ear 192 and the user 190.

In some embodiments, the method 1500 includes identifying, based on the first temperature, a risk associated with a low body temperature of the user. For example, the risk may be associated with the onset of hypothermia. In some such embodiments, the method 1500 may include generating a notification that indicates the risk, and outputting the notification via the speaker or sending the notification to a host device. The notification may include or correspond to the notification 162.

In some embodiments, the method 1500 includes communicating, via a wireless communication transceiver, data between the audio device and the host device. The wireless communication transceiver may include or correspond to the transceiver 118. The data communicated between the audio device and the host device may be associated with the audio, the first sensor data, the threshold, or a combination thereof.

In some embodiments, the method 1500 includes providing audio output data to a speaker of an audio device for output of audio to an ear of a user. The speaker may be coupled to the housing and/or at least a portion of the speaker may be positioned within the cavity. The audio output data and the speaker may include or correspond to the audio output data 164 and the speaker 112, 608, 708, 812, 908, respectively. In some embodiments, the method 1500 includes obtaining the audio output data, and providing the audio output data to the speaker. To illustrate, the method 1500 may include receiving, via a modem, an audio signal from a second device, and outputting, via the speaker, the audio based on the audio signal. The second device may include or correspond to a host device, such as the host device 180, the mobile device 1001, the voice-controlled speaker system 1101, the wearable electronic device 1201, or the vehicle 1301 or 1401. Additionally, or alternatively, the method 1500 may include outputting, via the speaker, the audio based on the audio output data.

At block 1506, the method 1500 further includes controlling, based on a result of a comparison associated with the first temperature and a threshold, heat generation of a heat element of the audio device. The threshold and the result may include or correspond to the threshold 132 and the result 160, respectively. In some embodiments, the threshold includes a temperature range, and the result of the comparison indicates whether the first temperature satisfies the temperature range. Additionally, or alternatively, the method 1500 can include performing the comparison based on the first temperature and the threshold.

The heat element may include or correspond to the heat element 120, 620, 720, 820, or 920. The heat element may include a graphene heat element, a carbon fiber heat element, or a combination thereof. In some embodiments, the heat element is positioned within the housing and/or the interface (e.g., the ear tip or the padding).

In some embodiments, controlling the heating element includes regulating an amount of power supplied to the heat element. To regulate the amount of power, the method 1500 may include generating a PWM signal and providing the PWM signal to the heat element.

In some embodiments, the method 1500 includes receiving, from a second temperature sensor of the audio device, second sensor data that indicates an ambient temperature. For example, the second temperature sensor may include or correspond to the sensor 110 or the second temperature sensor 152, 652, 752, 852, or 952. As an illustrative, non-limiting example, the second temperature sensor may include a thermistor. In some such embodiments, the heat generation of the heat element is controlled further based on the ambient temperature.

In some embodiments, the method 1500 includes storing, at a memory, the first sensor data, the second sensor data, or a combination thereof. For example, the memory may include or correspond to the memory 106 or 506.

In some embodiments, the method 1500 includes preventing, by an anti-fogging agent, formation of condensation on a surface to which the anti-fogging agent is coupled. The anti-fogging agent may be coupled to the housing, one or more electrical components positioned within the cavity, or a combination thereof. Additionally, or alternatively, the method 1500 may include generating, by a moisture sensor positioned within the cavity, moisture data that indicates an amount of moisture within the cavity. The moisture sensor may include or correspond to the moisture sensor 156. The method 1500 may include controlling the heat element based on the moisture data.

In some embodiments, the method 1500 includes receiving, from a third temperature sensor positioned within the cavity. For example, the third temperature sensor may include or correspond to the third temperature sensor 154. The third temperature data may indicate a cavity temperature within the cavity. In some such embodiment, the method 1500 includes controlling the heat element based further on the cavity temperature.

In some embodiments, the method 1500 includes receiving, from an input device, a user input. The input device and the user input may include or correspond to the input device 114 and the input data 115, respectively. The user input may indicate a mode of operation, the threshold, a target temperature, or a combination thereof.

In some embodiments, the method 1500 includes receiving, from a battery sensor coupled to a battery, a power indicator based on a state associated with the battery. For example, the battery and the battery sensor may include or correspond to the power supply 116 and the power sensor 158, respectively. In some such embodiments, the method 1500 includes controlling the heat element based on the power indicator. For example, the heat element may be deactivated based on the power indicator indicating a low power condition-e.g., a power level that is less than or equal to a low power threshold.

In some embodiments, the method 1500 includes turning off the audio device or the heat element based on a battery power level, a detected health condition associated with the user, an internal cavity temperature of the audio device, a detected fault condition, a threshold set by the user, or a combination thereof. To illustrate, the audio device or the heat element may be turned off based on a power level being less than or equal to a low power threshold. As another example, the audio device or the heat element may be turned off based on the internal cavity temperature being greater than or equal to an overheat threshold. As another example, the heat element may be turned off based on the threshold set by the user that indicates a maximum body temperature threshold of the user.

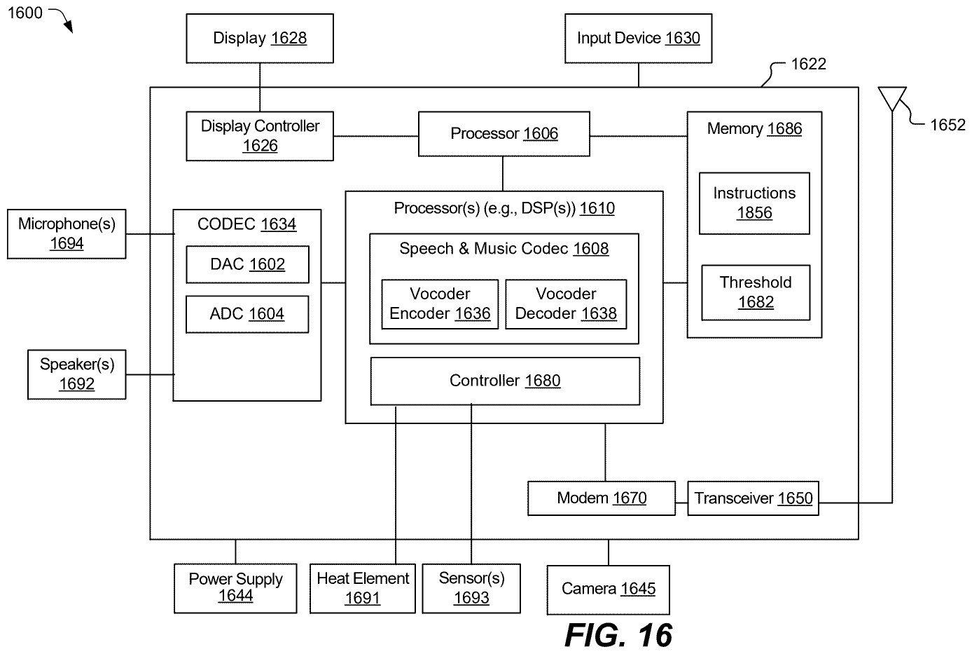

The method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1500 of FIG. 15 may be performed by a processor that executes instructions, such as described with reference to FIG. 16.

It is noted that one or more blocks (or operations) described with reference to FIG. 2 or 15 may be combined with one or more blocks (or operations) described with reference to another of the figures. For example, one or more blocks (or operations) of FIG. 15 may be combined with one or more blocks (or operations) of FIG. 2. As another example, one or more blocks associated with FIG. 2 or 15 may be combined with one or more blocks (or operations) associated with FIG. 1 or 3-14. Additionally, or alternatively, one or more operations described above with reference to FIGS. 1-15 may be combined with one or more operations described with reference to FIG. 16.

Referring to FIG. 16, FIG. 16 is a block diagram of an illustrative example of a device 1600 that is operable to support adaptive temperature control, in accordance with one or more aspects of the present disclosure. In various implementations, the device 1600 may have more or fewer components than illustrated in FIG. 16. In an illustrative implementation, the device 1600 may correspond to the audio device 102. In an illustrative implementation, the device 1600 may perform one or more operations described with reference to FIGS. 1-15.

In a particular implementation, the device 1600 includes a processor 1606 (e.g., a central processing unit (CPU)). The device 1600 may include one or more additional processors 1610 (e.g., one or more DSPs). In a particular aspect, the processor 108 of FIG. 1 or the processor 508 of FIG. 5 corresponds to the processor 1606, the processors 1610, or a combination thereof. The processors 1610 may include a speech and music coder-decoder (CODEC) 1608 that includes a voice coder (“vocoder”) encoder 1636, a vocoder decoder 1638, a controller 1680, or a combination thereof. The controller 1680 may include or correspond to the controller 140 or 540. Although the controller 1680 is described as being included in the processor 1610, in other embodiments, the controller 1680 is included in the processor 1606.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1600 may include a memory 1686 and a CODEC 1634. The memory 1686 may include or correspond to the memory 106 of FIG. 1 or the memory 506 of FIG. 5. The memory 1686 may include instructions 1656, that are executable by the one or more additional processors 1610 (or the processor 1606) to implement the functionality described with reference to the controller 1680. The instructions 1656 may include or correspond to the instructions 109 of FIG. 1. The memory 1686 may also include a threshold 1682. The threshold 1682 may include or correspond to the threshold 132 or 532. The device 1600 may include a modem 1670 coupled, via a transceiver 1650, to an antenna 1652. The modem 1670 and/or the transceiver 1650 may include or correspond to the transceiver 118.

The device 1600 may include a display 1628 coupled to a display controller 1626. One or more speakers 1692, one or more microphone(s) 1694, or both, may be coupled to the CODEC 1634. The speaker 1692 may include or correspond to the speaker 112 or a speaker of any of the devices of FIGS. 6-9. The microphone(s) 1694 may include or correspond to the microphone 104 or a microphone any of the devices of FIGS. 6-9. The CODEC 1634 may include a digital-to-analog converter (DAC) 1602, an analog-to-digital converter (ADC) 1604, or both. In a particular implementation, the CODEC 1634 may receive analog signals from the microphone(s) 1694, convert the analog signals to digital signals using the analog-to-digital converter 1604, and provide the digital signals to the speech and music codec 1608. The speech and music codec 1608 may process the digital signals. In a particular implementation, the speech and music codec 1608 may provide digital signals to the CODEC 1634. The CODEC 1634 may convert the digital signals to analog signals using the digital-to-analog converter 1602 and may provide the analog signals to the speaker 1692.

In a particular implementation, the device 1600 may be included in a system-in-package or system-on-chip device 1622. In a particular implementation, the memory 1686, the processor 1606, the processors 1610, the display controller 1626, the CODEC 1634, and the modem 1670 are included in the system-in-package or system-on-chip device 1622. In a particular implementation, an input device 1630, a power supply 1644, a camera 1645, a heat element 1691, and one or more sensors 1693 are coupled to the system-in-package or the system-on-chip device 1622. For example, the input device 1630, the heat element 1691, and the one or more sensors 1693 may include or correspond to the input device 114, the heat element 120, and the sensor(s) 110, respectively. In some examples, the input device 1630 may include or be associated with the display 1628. Moreover, in a particular implementation, as illustrated in FIG. 16, the display 1628, the input device 1630, the speaker(s) 1692, the microphone(s) 1694, the antenna 1652, the power supply 1644, and the camera 1645 are external to the system-in-package or the system-on-chip device 1622. In a particular implementation, each of the display 1628, the input device 1630, the speaker(s) 1692, the microphone(s) 1694, the antenna 1652, the power supply 1644, and the camera 1645 may be coupled to a component of the system-in-package or the system-on-chip device 1622, such as an interface or a controller.

The device 1600 may include a headset, an augmented reality headset, a mixed reality headset, a virtual reality headset, a portable electronic device, a computing device, a communication device, an internet-of-things (IoT) device, a virtual reality (VR) device, an earbud, a hearing aid, or any combination thereof.

In conjunction with the described implementations, an apparatus includes means for generating first sensor data that indicates a first temperature associated with an ear of a user. For example, the means for generating the first sensor data can include the sensor 110 or 1693, the first temperature sensor 150, 650, 750, 850, or 950, the headset device 600, the headset 700, the portable electronic device 800, the hearing aid device 900, the device 1600, other circuitry configured to generate the first sensor data, or a combination thereof.

The apparatus further includes means for generating heat. For example, the means for generating the heat can include the audio device 102, the processor 108 or 508, the heat element 120, 620, 720, 820, 920, or 1691, the controller 140, 540 or 1680, the heat element controller 144, the integrated circuit 500, the headset device 600, the headset 700, the portable electronic device 800, the hearing aid device 900, the processor 1606, the processor(s) 1610, the system-in-package or the system-on-chip device 1622, the device 1600, other circuitry configured to generate the heat, or a combination thereof.

The apparatus includes means for controlling, based on a result of a comparison associated with the first temperature and a threshold, the means for generating heat. For example, the means for controlling can include the audio device 102, the processor 108 or 508, the controller 140, 540, or 1680, the heat element controller 144, the integrated circuit 500, the headset device 600, the headset 700, the portable electronic device 800, the hearing aid device 900, the processor 1606, the processor(s) 1610, the system-in-package or the system-on-chip device 1622, the device 1600, other circuitry configured to control the means for generating, or a combination thereof.

In some implementations, a non-transitory computer-readable medium (e.g., a computer-readable storage device, such as the memory 1686) includes instructions (e.g., the instructions 1656) that, when executed by one or more processors (e.g., the one or more processors 1610 or the processor 1606), cause the one or more processors to receive, from a first temperature sensor of an audio device, first sensor data that indicates a first temperature associated with an ear of a user. The instructions also cause the one or more processors to perform a comparison based on the first temperature and a threshold. The instructions further cause the one or more processors to control, based on a result of the comparison, heat generation of a heat element of the audio device.

Particular aspects of the disclosure are described below in sets of interrelated Examples:

According to Example 1, an audio device includes: a first temperature sensor configured to generate first sensor data that indicates a first temperature associated with an ear of a user; a heat element configured to generate heat; and one or more processors configured to receive the first sensor data from the first temperature sensor; and control the heat element based on a result of a comparison associated with the first temperature and a threshold.

Example 2 includes the audio device of Example 1, where: the first temperature is a temperature of an outer portion of the ear, and the one or more processors are configured to perform the comparison based on the first temperature and the threshold.

Example 3 includes the audio device of Example 1 or Example 2, where: the threshold includes a temperature range, the result of the comparison indicates whether the first temperature satisfies the temperature range, and the one or more processors are configured to periodically receive the first sensor data from the first temperature sensor.

Example 4 includes the audio device of any of Examples 1 to 3, and further includes a second temperature sensor configured to generate second sensor data that indicates an ambient temperature, where the one or more processors are configured to control the heat element based further on the ambient temperature.

Example 5 includes the audio device of Example 4, where: the first temperature sensor includes an infrared sensor configured to measure the temperature of an ear canal of the user, the second temperature sensor includes a thermistor, the heat element includes a graphene heat element, a carbon fiber heat element, or a combination thereof, and to control the heating element, the one or more processors are configured to regulate an amount of power supplied to the heat element.

Example 6 includes the audio device of Example 4 or Example 5, and further includes a memory coupled to the one or more processors and configured to store the first sensor data, the second sensor data, or a combination thereof.

Example 7 includes the audio device of any of Examples 1 to 6, where the one or more processors are configured to turn off the audio device based on a battery power level, a detected health condition associated with the user, an internal cavity temperature of the audio device, a detected fault condition, a threshold set by the user, or a combination thereof.

Example 8 includes the audio device of any of Examples 1 to 7, and further includes a housing that defines a cavity, where the one or more processors are positioned within the cavity.

Example 9 includes the audio device of Example 8, and further includes an interface coupled to the housing, the interface including an ear tip configured to be positioned within an ear canal of the user or padding of an over-ear earcup, where the heat element is positioned within the housing, the ear tip, or the padding.

Example 10 includes the audio device of Example 8 or Example 9, and further includes an anti-fogging agent coupled to the housing, one or more electrical components positioned within the cavity, or a combination thereof, the anti-fogging agent configured to prevent formation of condensation on a surface to which the anti-fogging agent is coupled.

Example 11 includes the audio device of any of Examples 8 to 10, and further includes a moisture sensor positioned within the cavity and configured to generate moisture data that indicates an amount of moisture within the cavity, where the one or more processors are configured to control the heat element based on the moisture data.

Example 12 includes the audio device of any of Examples 8 to 11, and further includes a third temperature sensor positioned within the cavity and configured to generate third temperature data that indicates a cavity temperature within the cavity, where the one or more processors are configured to control the heat element based further on the cavity temperature.

Example 13 includes the audio device of any of Examples 1 to 12, where the one or more processors are configured to: identify, based on the first temperature, a risk associated with a low body temperature of the user; generate a notification that indicates the risk; and output the notification via a speaker or send the notification to a host device.

Example 14 includes the audio device of any of Examples 1 to 13, and further includes an input device configured to receive a user input, where the user input indicates a mode of operation, the threshold, a target temperature, or a combination thereof.

Example 15 includes the audio device of any of Examples 1 to 14, and further includes: a battery; and a battery sensor coupled to the battery and configured to generate a power indicator based on a state associated with the battery, where the one or more processors are configured to control the heat element based on the power indicator.

Example 16 includes the audio device of any of Examples 1 to 15, and further includes a wireless communication transceiver configured to enable data communication between the audio device and a host device, the data communication associated with the audio, the first sensor data, the threshold, or a combination thereof.

Example 17 includes the audio device of any of Examples 1 to 16, and further including a speaker configured to output audio to the ear of the user, and where: the one or more processors are configured to obtain audio output data; and provide the audio output data to the speaker; and the speaker is configured to output the audio based on the audio output data.

Example 18 includes the audio device of Example 117, and further includes a modem coupled to the one or more processors, where the modem is configured to receive an audio signal from a second device, and where the speaker is configured to output the audio based on the audio signal.

Example 19 includes the audio device of any of Examples 1 to 18, where the audio device is a headset device that further includes a microphone; and the microphone is configured to provide an input signal to the one or more processors.

Example 20 includes the audio device of any of Examples 1 to 19, where the audio device is an earbud, a hearing aid device, a mixed reality or augmented reality glasses device, a headset, a virtual reality headset, a mixed reality headset, an augmented reality headset, or a hearing protection device.

According to Example 21, a method of operating a processor of an audio device, the method includes: receiving, from a first temperature sensor of an audio device, first sensor data that indicates a first temperature associated with an ear of a user; and controlling, based on a result of a comparison associated with the first temperature and a threshold, heat generation of a heat element of the audio device.

Example 22 includes the method of Example 21, and further includes performing the comparison based on the first temperature and the threshold, where the first temperature is a temperature of an outer portion of the ear.

Example 23 includes the method of Example 21 or Example 22, where: the threshold includes a temperature range, the result of the comparison indicates whether the first temperature satisfies the temperature range, and the first sensor data is received periodically from the first temperature sensor.

Example 24 includes the method of any of Examples 21 to 23, and further includes receiving, from a second temperature sensor of the audio device, second sensor data that indicates an ambient temperature, where the heat generation of the heat element is controlled further based on the ambient temperature.

Example 25 includes the method of Example 24, where: the first temperature sensor includes an infrared sensor that is configured to measure the temperature of an ear canal of the user, the second temperature sensor includes a thermistor, the heat element includes a graphene heat element, a carbon fiber heat element, or a combination thereof, and controlling the heating element includes regulating an amount of power supplied to the heat element.

Example 26 includes the method of Example 24 or Example 25, and further includes storing, at a memory, the first sensor data, the second sensor data, or a combination thereof.

Example 27 includes the method of any of Examples 21 to 26, and further includes turning off the audio device based on a battery power level, a detected health condition associated with the user, an internal cavity temperature of the audio device, a detected fault condition, a threshold set by the user, or a combination thereof.

Example 28 includes the method of any of Examples 21 to 27, where a housing of the audio device defines a cavity, and where a speaker is coupled to the housing and positioned within the cavity.

Example 29 includes the method of Example 28, where an interface is coupled to the housing, the interface includes an ear tip configured to be positioned within an ear canal of the user or padding of an over-ear earcup, and where the heat element is positioned within the housing, the ear tip, or the padding.

Example 30 includes the method of Example 28 or Example 29, and further includes preventing, by an anti-fogging agent, formation of condensation on a surface to which the anti-fogging agent is coupled, where the anti-fogging agent is coupled to the housing, one or more electrical components positioned within the cavity, or a combination thereof.

Example 31 includes the method of any of Examples 28 to 30, and further includes: generating, by a moisture sensor positioned within the cavity, moisture data that indicates an amount of moisture within the cavity, and controlling the heat element based on the moisture data.

Example 32 includes the method of any of Examples 28 to 31, and further includes: receiving, from a third temperature sensor positioned within the cavity, third temperature data that indicates a cavity temperature within the cavity; and controlling the heat element based further on the cavity temperature.

Example 33 includes the method of any of Examples 21 to 32, and further includes: identifying, based on the first temperature, a risk associated with a low body temperature of the user; generating a notification that indicates the risk; and outputting the notification via a speaker or sending the notification to a host device.

Example 34 includes the method of any of Examples 21 to 33, and further includes receiving, from an input device, a user input, where the user input indicates a mode of operation, the threshold, a target temperature, or a combination thereof.

Example 35 includes the method of any of Examples 21 to 34, and further includes: receiving, from a battery sensor coupled to a battery, a power indicator based on a state associated with the battery; and controlling the heat element based on the power indicator.

Example 36 includes the method of any of Examples 21 to 35, and further includes communicating, via a wireless communication transceiver, data between the audio device and a host device, the data associated with the audio, the first sensor data, the threshold, or a combination thereof.

Example 37 includes the method of any of Examples 21 to 36, and further includes: obtaining audio output data; providing the audio output data to a speaker; and outputting, via the speaker, the audio based on the audio output data.

Example 38 includes the method of any of Examples 21 to 37, where the audio device is a headset device.

Example 39 includes the method of any of Examples 21 to 38, where the audio device is an earbud, a hearing aid device, a mixed reality or augmented reality glasses device, a virtual reality headset, a mixed reality headset, an augmented reality headset, or a hearing protection device.

Example 40 includes the method of any of Examples 21 to 39, and further includes receiving, via a modem, an audio signal from a second device; and outputting, via a speaker, the audio based on the audio signal.

According to Example 41, a non-transitory computer-readable medium storing instructions that are executable by one or more processors to cause the one or more processors to receive, from a first temperature sensor of an audio device, first sensor data that indicates a first temperature associated with an ear of a user; perform a comparison based on the first temperature and a threshold; and control, based on a result of the comparison, heat generation of a heat element of the audio device.

Example 42 includes the non-transitory computer-readable medium of Example 41, where the instructions are further executable by the one or more processors to cause the one or more processors to perform the comparison based on the first temperature and the threshold, and where the first temperature is a temperature of an outer portion of the ear.

Example 43 includes the non-transitory computer-readable medium of Example 41 or Example 42, where: the threshold includes a temperature range, the result of the comparison indicates whether the first temperature satisfies the temperature range, and the first sensor data is received periodically from the first temperature sensor.

Example 44 includes the non-transitory computer-readable medium of any of Examples 41 to 43, where the instructions are further executable by the one or more processors to cause the one or more processors to receive, from a second temperature sensor of the audio device, second sensor data that indicates an ambient temperature, and where the heat generation of the heat element is controlled further based on the ambient temperature.

Example 45 includes the non-transitory computer-readable medium of Example 44, where: the first temperature sensor includes an infrared sensor that is configured to measure the temperature of an ear canal of the user, the second temperature sensor includes a thermistor, the heat element includes a graphene heat element, a carbon fiber heat element, or a combination thereof, and controlling the heating element includes regulating an amount of power supplied to the heat element.

Example 46 includes the non-transitory computer-readable medium of Example 44 or Example 45, where the instructions are further executable by the one or more processors to cause the one or more processors to store the first sensor data, the second sensor data, or a combination thereof.

Example 47 includes the non-transitory computer-readable medium of any of Examples 41 to 46, where the instructions are further executable by the one or more processors to cause the one or more processors to turn off the audio device based on a battery power level, a detected health condition associated with the user, an internal cavity temperature of the audio device, a detected fault condition, a threshold set by the user, or a combination thereof.

Example 48 includes the non-transitory computer-readable medium of any of Examples 41 to 47, where a housing of the audio device defines a cavity, and where a speaker is coupled to the housing and positioned within the cavity.

Example 49 includes the non-transitory computer-readable medium of Example 48, where an interface is coupled to the housing, the interface includes an ear tip configured to be positioned within an ear canal of the user or padding of an over-ear earcup, and where the heat element is positioned within the housing, the ear tip, or the padding.

Example 50 includes the non-transitory computer-readable medium of Example 48 or Example 49, where an anti-fogging agent is coupled to a surface of the housing, one or more electrical components positioned within the cavity, or a combination thereof.

Example 51 includes the non-transitory computer-readable medium of any of Examples 48 to 50, where the instructions are further executable by the one or more processors to cause the one or more processors to: receive, from a moisture sensor positioned within the cavity, moisture data that indicates an amount of moisture within the cavity; and control the heat element based on the moisture data.

Example 52 includes the non-transitory computer-readable medium of any of Examples 48 to 51, where the instructions are further executable by the one or more processors to cause the one or more processors to: receive, from a third temperature sensor positioned within the cavity, third temperature data that indicates a cavity temperature within the cavity; and control the heat element based further on the cavity temperature.

Example 53 includes the non-transitory computer-readable medium of any of Examples 41 to 52, where the instructions are further executable by the one or more processors to cause the one or more processors to: identify, based on the first temperature, a risk associated with a low body temperature of the user; generate a notification that indicates the risk; and output the notification via a speaker or send the notification to a host device.

Example 54 includes the non-transitory computer-readable medium of any of Examples 41 to 53, where the instructions are further executable by the one or more processors to cause the one or more processors to receive, from an input device, a user input, and where the user input indicates a mode of operation, the threshold, a target temperature, or a combination thereof.

Example 55 includes the non-transitory computer-readable medium of any of Examples 41 to 54, where the instructions are further executable by the one or more processors to cause the one or more processors to: receive, from a battery sensor coupled to a battery, a power indicator based on a state associated with the battery; and control the heat element based on the power indicator.

Example 56 includes the non-transitory computer-readable medium of any of Examples 41 to 55, where the instructions are further executable by the one or more processors to cause the one or more processors to communicate, via a wireless communication transceiver, data between the audio device and a host device, and where the data is associated with the audio, the first sensor data, the threshold, or a combination thereof.

Example 57 includes the non-transitory computer-readable medium of any of Examples 41 to 56, where the instructions are further executable by the one or more processors to cause the one or more processors to: obtain audio output data; and provide the audio output data to a speaker for output of the audio based on the audio output data.

Example 58 includes the non-transitory computer-readable medium of any of Examples 41 to 57, where the audio device is a headset device.

Example 59 includes the non-transitory computer-readable medium of any of Examples 41 to 58, where the audio device is an earbud, a hearing aid device, a mixed reality or augmented reality glasses device, a virtual reality headset, a mixed reality headset, an augmented reality headset, or a hearing protection device.

Example 60 includes the non-transitory computer-readable medium of any of Examples 41 to 59, where the instructions are further executable by the one or more processors to cause the one or more processors to receive, via a modem, an audio signal from a second device; and outputting, via a speaker, the audio based on the audio signal.

According to Example 61, an apparatus includes: means for generating first sensor data that indicates a first temperature associated with an ear of a user; means for generating heat; and means for controlling, based on a result of a comparison associated with the first temperature and a threshold, the means for generating heat.

Example 62 includes the apparatus of Example 61, and further includes means for performing the comparison based on the first temperature and the threshold, where the first temperature is a temperature of an outer portion of the ear.

Example 63 includes the apparatus of Example 61 or Example 62, where: the threshold includes a temperature range, the result of the comparison indicates whether the first temperature satisfies the temperature range, and the first sensor data is received periodically from the first temperature sensor.

Example 64 includes the apparatus of any of Examples 61 to 63, and further includes means for generating second sensor data that indicates an ambient temperature, where the means for controlling the means for generating heat is further configured to control the means for generating heat based on the second sensor data.

Example 65 includes the apparatus of Example 64, where: the means for generating the first sensor data includes an infrared sensor that is configured to measure the temperature of an ear canal of the user, the means for generating the second sensor data includes a thermistor, the means for generating heat includes a graphene heat element, a carbon fiber heat element, or a combination thereof, and the means for controlling the heating element includes a means for regulating an amount of power supplied to the means for generating heat.

Example 66 includes the apparatus of Example 64 or Example 65, and further includes means for storing the first sensor data, the second sensor data, or a combination thereof.

Example 67 includes the apparatus of any of Examples 61 to 66, and further includes means for turning off the apparatus based on a battery power level, a detected health condition associated with the user, an internal cavity temperature of the apparatus, a detected fault condition, a threshold set by the user, or a combination thereof.

Example 68 includes the apparatus of any of Examples 61 to 67, and further includes a means for defining a cavity; and the means for outputting of audio that is coupled to the means for defining the cavity and is positioned within the cavity.

Example 69 includes the apparatus of Examples 68, and further includes means for interfacing with the user is coupled to the means for defining.

Example 70 includes the apparatus of Examples 69, and further includes the means for interfacing with the user includes an ear tip configured to be positioned within an ear canal of the user or padding of an over-ear earcup.

Example 71 includes the apparatus of Examples 70, where the means for generating heat is positioned within the means for defining the cavity, the ear tip, or the padding.

Example 72 includes the apparatus of any of Examples 68 to 71, and further includes means for preventing formation of condensation on a surface to which the means for preventing is coupled, where the means for preventing is coupled to the means for defining, one or more electrical components positioned within the cavity, or a combination thereof.

Example 73 includes the apparatus of any of Examples 68 to 72, and further includes: means for generating moisture data that indicates an amount of moisture within the cavity, and where the means for controlling the means for generating heat is configured to control the means for generating heat based on the moisture data.

Example 74 includes the apparatus of any of Examples 68 to 73, and further includes: means for receiving third temperature data that indicates a cavity temperature within the cavity; and where the means for controlling the means for generating heat is configured to control the means for generating heat based on the cavity temperature.

Example 75 includes the apparatus of any of Examples 61 to 74, and further includes: means for identifying, based on the first temperature, a risk associated with a low body temperature of the user; means for generating a notification that indicates the risk; and means for outputting the notification.

Example 76 includes the apparatus of any of Examples 61 to 75, and further includes means for receiving a user input, where the user input indicates a mode of operation, the threshold, a target temperature, or a combination thereof.

Example 77 includes the apparatus of any of Examples 61 to 76, and further includes: means for generating a power indicator based on a state associated with a battery, and where the means for controlling the means for generating heat is configured to control the means for generating heat based on the power indicator.

Example 78 includes the apparatus of any of Examples 61 to 77, and further includes the means for communicating data between the audio device and a host device, the data associated with the audio, the first sensor data, the threshold, or a combination thereof.

Example 79 includes the apparatus of any of Examples 61 to 78, and further includes: means for obtaining audio output data; and means for providing the audio output data to means for outputting audio.

Example 80 includes the apparatus of any of Examples 61 to 79, where the apparatus is a headset device.

Example 81 includes the apparatus of any of Examples 61 to 80, where the apparatus is an earbud, a hearing aid device, a mixed reality or augmented reality glasses device, a virtual reality headset, a mixed reality headset, an augmented reality headset, or a hearing protection device.

Example 82 includes the apparatus of any of Examples 61 to 81, and further includes means for receiving an audio signal from a second device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. An audio device comprising:
a first temperature sensor configured to generate first sensor data that indicates a first temperature associated with an ear of a user;
a heat element configured to generate heat; and
one or more processors configured to:
receive the first sensor data from the first temperature sensor; and
control the heat element based on a result of a comparison associated with the first temperature and a threshold.

2. The audio device of claim 1, wherein:
the first temperature is a temperature of an outer portion of the ear, and
the one or more processors are configured to perform the comparison based on the first temperature and the threshold.

3. The audio device of claim 1, wherein:
the threshold includes a temperature range,
the result of the comparison indicates whether the first temperature satisfies the temperature range, and
the one or more processors are configured to periodically receive the first sensor data from the first temperature sensor.

4. The audio device of claim 1, further comprising:
a second temperature sensor configured to generate second sensor data that indicates an ambient temperature,
wherein the one or more processors are configured to control the heat element based further on the ambient temperature.

5. The audio device of claim 4, wherein:
the first temperature sensor includes an infrared sensor configured to measure the temperature of an ear canal of the user,
the second temperature sensor includes a thermistor,
the heat element includes a graphene heat element, a carbon fiber heat element, or a combination thereof, and
to control the heating element, the one or more processors are configured to regulate an amount of power supplied to the heat element.

6. The audio device of claim 4, further comprising:
a memory coupled to the one or more processors and configured to store the first sensor data, the second sensor data, or a combination thereof, and
wherein the one or more processors are configured to turn off the audio device based on a battery power level, a detected health condition associated with a user, an internal cavity temperature of the audio device, a detected fault condition, a threshold set by the user, or a combination thereof.

7. The audio device of claim 1, further comprising:
a housing that defines a cavity, wherein the one or more processors are positioned within the cavity; and
an interface coupled to the housing, the interface including an ear tip configured to be positioned within an ear canal of the user or padding of an over-ear earcup,
wherein the heat element is positioned within the housing, the ear tip, or the padding.

8. The audio device of claim 7, further comprising:
an anti-fogging agent coupled to the housing, one or more electrical components positioned within the cavity, or a combination thereof, the anti-fogging agent configured to prevent formation of condensation on a surface to which the anti-fogging agent is coupled; and
a moisture sensor positioned within the cavity and configured to generate moisture data that indicates an amount of moisture within the cavity,
wherein the one or more processors are configured to control the heat element based on the moisture data.

9. The audio device of claim 7, further comprising:
a third temperature sensor positioned within the cavity and configured to generate third temperature data that indicates a cavity temperature within the cavity,
wherein the one or more processors are configured to control the heat element based further on the cavity temperature.

10. The audio device of claim 1, wherein the one or more processors are configured to:
identify, based on the first temperature, a risk associated with a low body temperature of the user;
generate a notification that indicates the risk; and
output the notification via a speaker or send the notification to a host device.

11. The audio device of claim 1, further comprising:
an input device configured to receive a user input,
wherein the user input indicates a mode of operation, the threshold, a target temperature, or a combination thereof.

12. The audio device of claim 1, further comprising:
a battery; and
a battery sensor coupled to the battery and configured to generate a power indicator based on a state associated with the battery,
wherein the one or more processors are configured to control the heat element based on the power indicator.

13. The audio device of claim 1, further comprising a wireless communication transceiver configured to enable data communication between the audio device and a host device, the data communication associated with the audio, the first sensor data, the threshold, or a combination thereof.

14. The audio device of claim 1, further comprising:
a speaker configured to output audio to the ear of the user, and
where:
the one or more processors are configured to:
obtain audio output data; and
provide the audio output data to the speaker; and
the speaker is configured to output the audio based on the audio output data.

15. The audio device of claim 14, further comprising a modem coupled to the one or more processors, wherein the modem is configured to receive an audio signal from a second device, and wherein the speaker is configured to output the audio based on the audio signal.

16. The audio device of claim 1, wherein:
the audio device is a headset device that further includes a microphone; and
the microphone is configured to provide an input signal to the one or more processors.

17. The audio device of claim 1, wherein the audio device is an earbud, a hearing aid device, a mixed reality or augmented reality glasses device, a headset, a virtual reality headset, a mixed reality headset, an augmented reality headset, or a hearing protection device.

18. A method of operating a processor of an audio device, the method comprising:
receiving, from a first temperature sensor of the audio device, first sensor data that indicates a first temperature associated with an ear of a user; and
controlling, based on a result of a comparison associated with the first temperature and a threshold, heat generation of a heat element of the audio device.

19. The method of claim 18, further comprising:
receiving, from a second temperature sensor of the audio device, second sensor data that indicates an ambient temperature,
wherein the heat generation of the heat element is controlled further based on the ambient temperature.

20. A non-transitory computer-readable medium storing instructions that are executable by one or more processors to cause the one or more processors to:
receive, from a first temperature sensor of the audio device, first sensor data that indicates a first temperature associated with an ear of a user; and
control, based on a result of the comparison associated with the first temperature and a threshold, heat generation of a heat element of the audio device.
